(19) United States
(12) Patent Application Publication
(10) Pub. No.: US 2017/0215035 A1
(43) Pub. Date: Jul. 27, 2017

(54) MOVABLE OBJECT MANAGEMENT SYSTEM AND BASE STATION

(71) Applicant: FUJITSU LIMITED, Kawasaki-shi (JP)

(72) Inventor: Teruhiko SENBA, Nasushiobara (JP)

(73) Assignee: FUJITSU LIMITED, Kawasaki-shi (JP)

(21) Appl. No.: 15/414,010

(22) Filed: Jan. 24, 2017

(30) Foreign Application Priority Data
Jan. 26, 2016 (JP) 2016-012631

(51) Int. Cl. H04W 4/02; H04W 8/26; H04W 48/12

(52) U.S. Cl. CPC H04W 4/021; H04W 48/12; H04W 8/26

(57) ABSTRACT

A movable object management system includes a base station configured to perform radio communication with a radio communication apparatus, and a controller configured to determine whether a movable object is present in an area associated with a regulation on the movable object, based on location information of the movable object received from the radio communication apparatus via the base station.

### CROSS-REFERENCE TO RELATED APPLICATION

This application is based upon and claims the benefit of priority of the prior Japanese Application No. 2016-012631 filed on Jan. 26, 2016, the entire contents of which are incorporated herein by reference.

### FIELD

The present invention relates to a movable object management system and a base station.

### BACKGROUND

A multicopter called a “drone” which is operated to fly by means of radio control is recently available at a low price and is generally easily available. In the current situation, the presence of rules for regulating the flight of the “drone” within the range that is not regulated by the aviation law is not clear. This may cause security problems, such as the entry of the “drone” into a prohibited area, even though the entry does not violate the aviation law, and this may also cause safety problems such as the flight of the “drone” over a crowded area.

In the field of mobile communication, location information of a radio terminal is registered in a network connected to a base station. The registered location information is used for, for example, location search of a called terminal, and handover of a radio terminal.

For further information, see Japanese National Publication of International Patent Application No. 2014-529916, and Japanese Laid-Open Patent Publication No. 2014-003674.

### SUMMARY

One of aspects is a movable object management system. The movable object management system includes a base station configured to perform radio communication with a radio communication apparatus and a controller configured to determine whether a movable object is present in an area associated with a regulation on the movable object, based on location information of the movable object received from the radio communication apparatus via the base station.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 illustrates an example of a network system according to a first embodiment;

FIG. 2 illustrates a configuration example of an information processor that operates as a management apparatus;

FIG. 3 is a flowchart illustrating a processing example according to the first embodiment;

FIG. 4 is a flowchart illustrating an example of a process during movement of a movable object;

FIG. 5 is a diagram illustrating a configuration example of a base station according to a second embodiment;

FIG. 6 is an explanatory diagram illustrating a protocol stack in a user plane of LTE;

FIG. 7 is an explanatory diagram illustrating a MAC PDU;

FIG. 8 is a table illustrating a MAC header;

FIG. 9 is a table illustrating LCID values of a UL-SCH;

FIG. 10 illustrates an example of mapping of location information on a MAC SDU;

FIG. 11 is a diagram illustrating a hardware configuration example of an REC;

FIG. 12 illustrates another configuration example of the base station (REC);

FIG. 13 illustrates a still further configuration example of the base station (REC);

FIG. 14 illustrates yet another configuration example of the base station (REC);

FIG. 15 is an explanatory diagram illustrating Method 1 for transmitting location information to the base station;

FIG. 16 illustrates a hardware configuration example of a movable object corresponding to Method 1;

FIG. 17 illustrates a hardware configuration example of an input apparatus;

FIG. 18 is an explanatory diagram illustrating Method 2;

FIG. 19 illustrates a hardware configuration example which may be used in Method 2;

FIG. 20 is an explanatory diagram illustrating Method 3;

FIG. 21 illustrates a configuration example of an input apparatus used in Method 3;

FIG. 22 is a flowchart illustrating a processing example during start-up of the movable object;

FIG. 23 is a flowchart illustrating a processing example of the base station;

FIG. 24 is a flowchart illustrating a processing example of the base station;

FIG. 25 is an explanatory diagram illustrating a prohibited area, a restricted area, and an alarm notification area;

FIG. 26 illustrates an example of a table storing thresholds for the prohibited area, the restricted area, and the alarm notification area;

FIG. 27 is a flowchart illustrating a process in the movable object after a start-up OK message is received;

FIG. 28 is a flowchart illustrating a process in the movable object after the start-up OK message is received;

FIG. 29 is a flowchart illustrating a process in the base station after the start-up OK message is transmitted;

FIG. 30 is a flowchart illustrating a process in the base station after the start-up OK message is transmitted; and

FIG. 31 is a flowchart illustrating a process in the base station after the start-up OK message is transmitted.

### DETAILED DESCRIPTION OF EMBODIMENT

Hereinafter, embodiments will be described with reference to the accompanying drawings. The configurations of the embodiments are merely an example, and the present invention is not limited to the configurations of the embodiment.

The embodiments illustrate a movable object management system including a base station and a controller. The base station performs radio communication with a radio communication apparatus. The controller determines whether a movable object is present in an area associated with a regulation on the movable object, based on location information of the movable object received from the radio communication apparatus via the base station.

The “movable object” described herein refers to a movable object including a propeller (a propeller-equipped movable object). Examples of the movable object include vehicles, such as an aircraft, a ship (including a submarine), a car, and a train, an object that resembles a vehicle, and objects other than these objects. The propeller is, for example, a rotor, a wing, an airscrew, a screw, or a wheel. The movable object may include a power source (an engine, a motor, or the like) for the propeller. The movable object need not necessarily include the power source.

The movable object is capable of propulsion (movement) based on information input from an input apparatus. The input apparatus is an input apparatus for inputting information to the movable object. The input apparatus is called, for example, a controller, a remote controller, a control panel, or a console.

Upon receiving a propeller control signal from the input apparatus, the movable object may change a propulsion direction, a propulsion altitude (propulsion depth), a propulsion speed, or the like. Alternatively, the movable object may perform automatic control (autonomous control) of the propeller based on information about an ambient environment. The information about the ambient environment may be input from the outside by means of communication, or may be detected by a sensor mounted on the movable object.

The movable object includes, for example, a Global Positioning System (GPS) receiver, and is capable of detecting location information (position coordinate, altitude) of the movable object. The movable object also includes one or more sensors, such as a gyroscopic sensor, an acceleration sensor, and a radar. The movable object may obtain the status of the ambient environment and automatically control the propeller. For example, the movable object may automatically control the propeller based on the location information obtained from the GPS receiver, posture information and speed information obtained from the gyroscopic sensor, and the like, and may move toward a target location input from the input apparatus.

The movable object may be manned or unmanned. The movable object may carry people and objects, but need not necessarily carry people and objects. The input apparatus is used to input parameters to a motion program for the movable object. The input apparatus may be an apparatus physically independent of the movable object, or may be an apparatus to be attached, mounted, or accommodated in the movable object. The input apparatus independent of the movable object may communicate with the movable object by radio communication or infrared communication.

The radio communication apparatus is included in at least one of the movable object and the input apparatus, and is connectable to a network via the base station. Connecting to the network enables the radio communication apparatus to transmit data to a desired communication counterpart and receive data therefrom. The radio communication apparatus has a radio terminal function for a radio network (network).

Upon receiving a connection request from the radio communication apparatus, the base station performs a process of connecting the radio communication apparatus to the network. After the radio communication apparatus is connected to the network, the radio communication apparatus relays the data transmitted and received between the radio communication apparatus and the communication counterpart. The base station includes a processing unit that performs processes for a plurality of protocols related to the radio communication.

The controller may be an apparatus that is provided separately from the base station, or may be an apparatus that is included in the base station. The controller may receive the location information of the movable object transmitted from the radio communication apparatus included in the movable object, or may receive the location information of the movable object transmitted from the radio communication apparatus included in the input apparatus that inputs information to the movable object. The location information of the movable object may be received by the base station from an apparatus other than the movable object and the input apparatus.

The controller determines whether the movable object is present in an area associated with a regulation on the movable object, based on the location information of the movable object. The area associated with the regulation on the movable object includes an area in which the entry or movement of the movable object is regulated (prohibited), an area in which the entry or movement of the movable object is restricted, and a peripheral area around these areas. Start-up of the movable object means a transition of the movable object to a movable state using the propeller. For example, the movable object is started by supply of power to the propeller included in the movable object, or by turning on the power source for supplying power to the propeller. When it is determined that a regulation needs to be made on the movable object, for example, a notification for prohibiting start-up of the movable object, or a notification for causing the movable object to transit from the start-up state of the movable object to an OFF state is transmitted. The notification is transmitted to at least one of the movable object and the input apparatus. The start-up is inhibited, thereby regulating the movement or entry of the movable object within the regulated area.

The regulation on the movement is, for example, a regulation on the propulsion direction of the movable object during movement. For example, it is possible to supply the movable object during movement with movement control information for the movable object to move to the outside of the regulated area, or to reach (land) a certain spot outside of the regulated area. This enables the movable object to avoid the entry into the regulated area, or to move to the outside of the regulated area. Further, the movement control information enables control of the altitude or speed of the movable object.

### First Embodiment

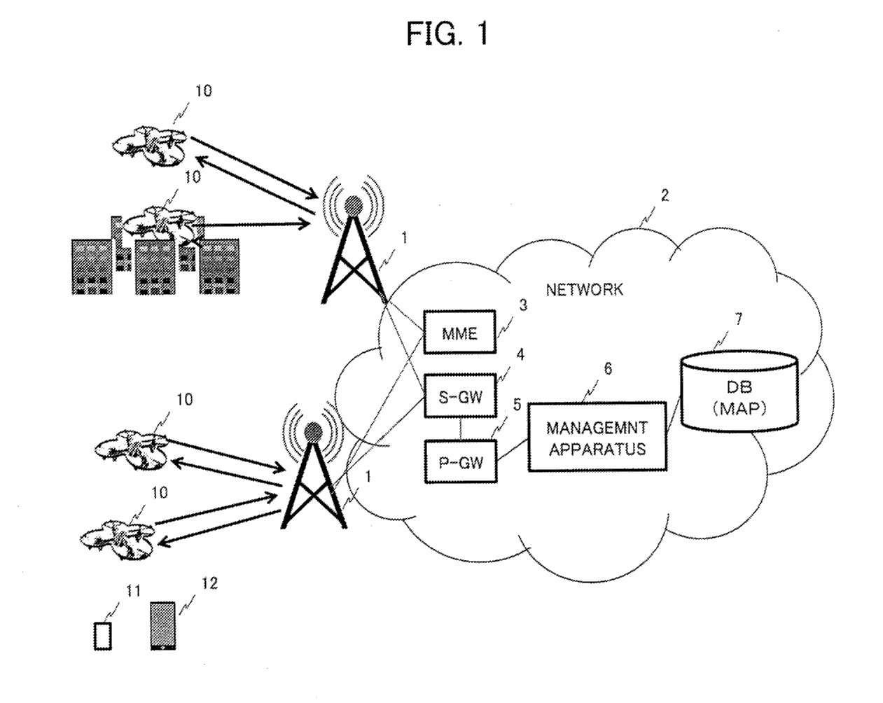

A first embodiment will be described below. FIG. 1 illustrates an example of a network system according to the first embodiment. The network system includes at least one base station 1 and a network 2.

FIG. 1 illustrates a Long Term Evolution (LTE) network as a network. The network may be a radio access network before the third generation, such as Wideband Code Division Multiple Access (W-CDMA) or High-Speed Downlink Packet Access (HDSPA), and may include a radio network such as radio Local Area Network (LAN) or Wi-Fi.

The base station 1 is an “eNB” in LTE. The network 2 includes a radio network formed by the base station 1, and a core network connected to the radio network. The core network is formed of a plurality of nodes. The plurality of nodes includes, for example, a Mobility Management Entity (MME) 3, a serving gateway (S-GW) 4, and a packet data network gateway (P-GW) 5.

The MME 3 is a control device that performs, for example, control for location registration of a radio terminal (referred to as a User Equipment (UE)), and control for establishing a packet transmission path (referred to as a bearer) between the UE and the P-GW. The S-GW4 performs packet communication with the UE via the base station. The P-GW 5 is a gateway between the core network and an external network.

A management apparatus 6 is connected to the P-GW 5 and is thereby connected to the network 2. The management apparatus 6 is connected to a database (DB) 7. The DB 7 may be included in the management apparatus 6, or may be included in an information processor which may communicate with the management apparatus 6. The management apparatus 6 is installed in, for example, a management center. The management apparatus 6 is one example of a “controller” or a “control unit”.

The embodiment illustrates a case where the movable object (movable object including a propeller) 10 is a so-called “drone”. However, the movable object may be a movable object other than the “drone”. This embodiment illustrates an example in which the movable object 10 includes a propeller, a power source, a control unit, a GPS receiver, a sensor, and a radio communication apparatus. In this embodiment, the movable object 10 includes a motor as the power source, and one or more rotors as the propeller.

When the movable object 10 receives, for example, destination information and a start-up trigger, from the input apparatus 11, the control unit of the movable object 10 controls the propeller based on the location information of the movable object 10 obtained from the GPS receiver and external peripheral information received from the sensor, so that the movable object flies to a destination. Further, the input apparatus 11 may transmit, by radio communication, a signal for changing the propulsion direction to the movable object 10 during flight. Thus, a user of the input apparatus 11 manipulates the movable object 10 so that the propulsion direction and altitude of the movable object 10 may be changed.

The radio communication apparatus has a radio terminal (UE) function. The radio communication apparatus wirelessly connects to the base station 1, and performs a process of connecting to the network with the MME 3 (a call process; registration of the location of the movable object 10; and establishment of a communication path). The connecting process allows the radio communication apparatus to be connected to the network 2 via the base station 1, and to communicate with a communication counterpart via the network 2. The management apparatus 6 is one example of the communication counterpart.

The radio communication apparatus (UE) is included in at least one of the movable object 10 and the input apparatus 11 for the movable object 10. The movable object 10 and the input apparatus 11 may include a radio communication apparatus different from the UE.

### <Configuration Example of Management Apparatus>

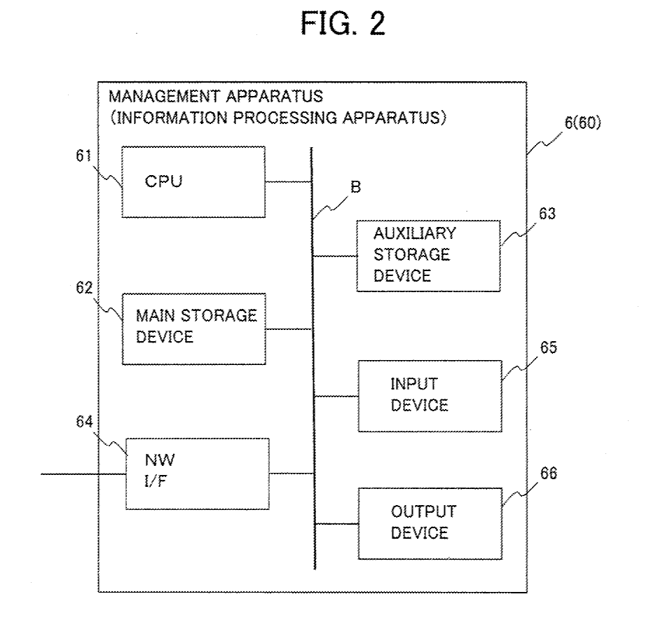

FIG. 2 illustrates a configuration example of an information processor 60 which is operable as the management apparatus 6. The information processor 60 is, for example, a general-purpose computer, such as a personal computer (PC) or a work station (WS), or a dedicated computer such as a server machine.

Referring to FIG. 2, the information processor 60 includes a Central Processing Unit (CPU) 61, a main storage device 62, an auxiliary storage device 63, a network interface circuit (NW I/F) 64, an input device 65, and an output device 66 which are interconnected via a bus B.

The main storage device 62 is used as a program to be executed by a CPU 61, a data storage area, a work area for the CPU 61, a communication data buffer area, and the like which are used to execute the program. The main storage device 62 is formed by a combination of, for example, a Random Access Memory (RAM), or a RAM and a Read Only Memory (ROM).

The auxiliary storage device 63 is used as a storage area for programs and data. Examples of the auxiliary storage device 63 include a hard disk drive (HDD), a Solid State Drive (SSD), a flash memory, and an Electrically Erasable Programmable Read-Only Memory (EEPROM). The auxiliary storage device 63 may include a disk storage medium.

The NW I/F 64 is an interface circuit that performs a communication process. As the NW I/F 64, for example, a LAN card, or a card device called a network interface card (NIC) may be applied.

The input device 65 is used to input information or data to the information processor 60. The input device 65 includes keys, buttons, a pointing device (a mouse or the like), and a touch panel. The input device 65 may include an audio input device such as a microphone. The output device 66 is used to output information. The output device 66 is, for example, a display or a printer. The output device 66 may include an audio output device such as a speaker.

The CPU 61 loads a program stored in at least one of the main storage device 62 and the auxiliary storage device 63 into the main storage device 62, and executes the program. This allows the information processor 60 to operate as the management apparatus 6. The DB 7 is stored in at least one of the main storage device 62 and the auxiliary storage device 63. The DB 7 may be formed in such a manner that the DB 7 is included in another information processor connected via the NW I/F 64 and the CPU 61 accesses the DB 7, as needed, to receive desired information. The CPU 61 is one example of a “processor”, a “control unit”, a “controller”, and a “control device”. Each of the main storage device 62 and the auxiliary storage device 63 is one example of a “memory”, a “storage device”, and a “computer-readable storage medium”.

The DB 7 includes information related to a regulation common to the movable objects 10. For example, the DB 7 includes information about an area associated with a regulation. The area includes, for example, a prohibited area in which the movement and entry of the movable object 10 are uniformly prohibited; a restricted area in which the movement and entry of movable objects 10 other than admitted movable objects 10 are prohibited, or the travelling speed or altitude are restricted while permission is unneeded; and a warning area in which warning is issued, while the movement and entry in the area are not prohibited. The area information may include map information. The map information may be managed separately from the area information.

The area information may be segmented into, for example, a common restricted area and an individual restricted area. The common restricted area is an area in which a major facility is present, and is designated as the prohibited area. An area around the prohibited area is designated as the restricted area or the like. Further, an area with an altitude that violates the aviation law is designated as the prohibited area. Further, the area in which the topography has a difference in altitude, such as an area with a large number of buildings, is designated as the prohibited area or the restricted area. An area crowded with obstacles or people which are not on the map, such as an event area, and a peripheral area thereof may be temporarily designated as the prohibited area or the restricted area.

The individual restricted area is an area in which prohibition or restriction is imposed on the use of the movable object 10 of the user. For example, when a user history includes a history based on which the use of the movable object 10 is restricted, the individual restricted area is designated. Each of the regulated area, the restricted area, the alarm notification area, the common restricted area, and the individual restricted area described above is one example of the “area associated with a regulation on the movable object”.

The DB 7 may include information indicating an operation state of the movable object 10. The operation state is associated with, for example, the identifier of the user of the movable object 10 or the identifier of the movable object 10. The operation state includes, for example, the location information (which may include an altitude) and the travelling speed of the movable object 10. The DB 7 stores a record indicating a transition of the location information (position coordinate) of the movable object 10 as information indicating the operation state.

The DB 7 may include, as user (owner) information, the identifier of the user, user's telephone number, e-mail address, information about the area in which the user's manipulation is permitted or prohibited, and information indicating a manipulation history and a manipulation technique of the movable object 10 of the user. The user's telephone number and e-mail address are one example of information indicating a “designated address”, and is used as a result of the determination performed by the control unit (management apparatus 6) and as information for designating the destination of a notification based on the determination result.

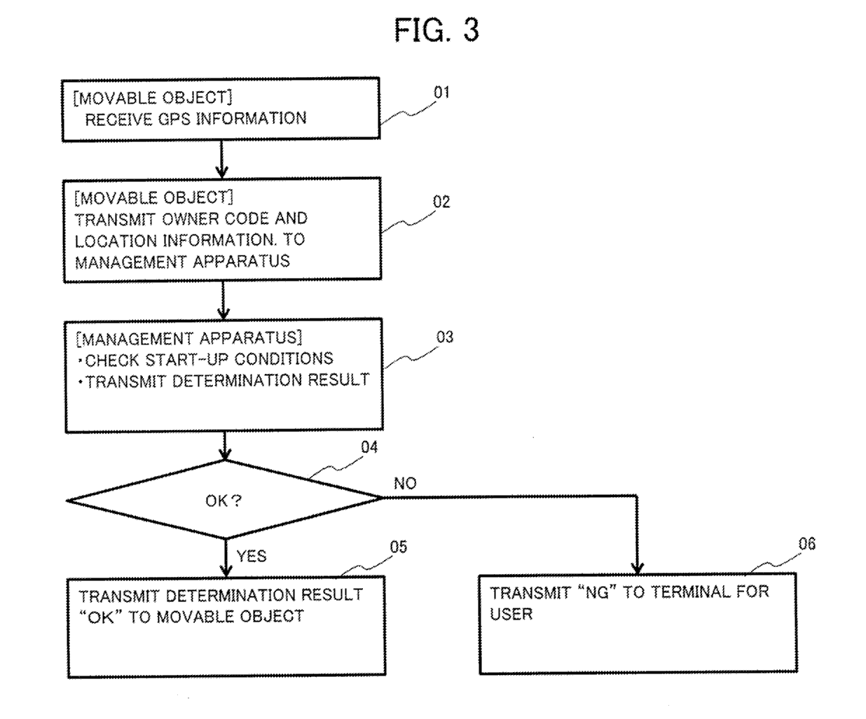

FIG. 3 is a flowchart illustrating a processing example in the first embodiment. The process illustrated in FIG. 3 is started when, for example, the user of the movable object 10 turns on the power supply of each of the input apparatus 11 and the movable object 10 at a certain spot so that the movable object 10 may fly. Assume that when the power supply is turned on, the OFF state of the power source (motor) or the propeller is locked and the power source and the propeller are unable to be turned on by manipulating the input apparatus 11. Turning on the power source and the propeller is one example of start-up of the movable object.

The movable object 10 uses the GPS receiver to measure the location of the movable object 10 based on a signal from a GPS satellite (01). The radio communication apparatus (UE) included in the movable object 10 performs radio connection with the base station 1, and performs a process of connecting to the network 2 via the base station 1. When the mobile terminal is connected to the network, the radio communication apparatus (UE) connects to the management apparatus 6, and transmits the owner code and the location information to the management apparatus 6 (02).

The location information is location information obtained using the GPS receiver, and is also called GPS information. The owner code is the identifier of the user of the movable object 10. The owner code is preliminarily stored in the memory included in the movable object 10. The location information (GPS information) is one example of the “location information”.

The management apparatus 6 (for example, the CPU 61 of the information processor 60) receives the owner code and the location information from the movable object 10 via the base station 1. The CPU 61 checks (confirms) start-up conditions using the owner code and the location information (determines whether start-up conditions are satisfied or not) (03). For example, the DB 7 stores the start-up condition that the movable object 10 is located outside of the regulated area. Conditions other than the above-mentioned condition may be set as the start-up conditions.

When the determination result indicates OK (for example, when the movable object 10 is located outside of the regulated area), the management apparatus 6 transmits a notification indicating the determination result OK to the movable object 10 (05). Upon receiving the notification indicating OK, the control unit included in the movable object 10 releases locking of the off state of the power source or the propeller. Accordingly, the power source and the propeller are turned on to enable the movable object 10 to fly.

When the determination result indicates NG (for example, when the movable object 10 is located in the regulated area), the management apparatus sends information to a terminal 12 (FIG. 1) of the user and notifies the terminal 12 that the determination result indicates NG. The notification may be a voice by a telephone call, an e-mail, or a short mail. The terminal 12 is a UE and is, for example, a smartphone, a future phone, a Personal Digital Assistant (PDA), or a tablet computer.

NG may be set during start-up, for example, when the communication between the movable object 10 (UE) and the management apparatus 6 is not normally performed (communication abnormal), when the owner code is not registered in the DB 7, or when the identifier of the movable object 10 which has been reported as stolen.

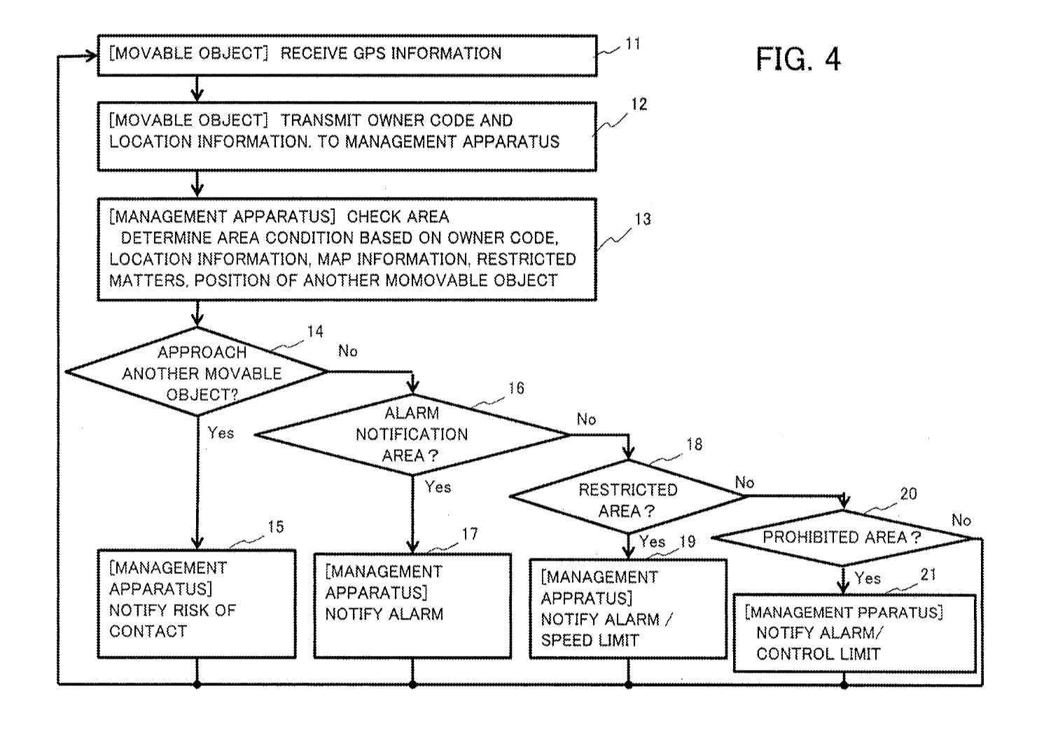

FIG. 4 is a flowchart illustrating an example of a process during movement of the movable object 10. The movable object 10 acquires the location information using the GPS receiver at an appropriate timing (for example, at a constant cycle), and transmits the location information as well as the owner ode to the management apparatus 6 (11, 12).

Upon receiving the owner code and the location information, the management apparatus 6 (CPU 61) acquires, from the DB 7, the corresponding map information, restricted matters (information about regulations), location information of another movable object, or the like, and determines area conditions (13). The determination as to the area conditions is made by, for example, the following processes.

The management apparatus 6 determines whether or not another movable object is approaching (14). The determination may be made by comparing the location information of the movable object 10 with the location information of another movable object and determining whether the distance between the locations is smaller than a threshold.

When it is determined that another movable object is approaching (Yes in 14), the management apparatus 6 notifies the terminal 12 of the user, whose telephone number and e-mail address are registered in the DB 7, that there is a risk of contact (15). The notification may be performed by, for example, any one of a telephone call (audio message), an e-mail, and a short mail (the same holds true for the notification in the processes 17, 18, and 21 described below). The terminal 12 of the user is one example of the “designated address”.

When it is determined that another movable object is not approaching (No in 14), the management apparatus 6 determines whether or not the location of the movable object 10 is in the alarm notification area (16). When the location is in the alarm notification area (Yes in 16), the management apparatus 6 notifies the terminal 12 of an alarm.

When the location is not in the alarm notification area (No in 16), the management apparatus 6 determines whether or not the location of the movable object 10 is in the restricted area (18). For example, when the location is in the restricted area and the speed exceeds a threshold (Yes in 18), the management apparatus 6 notifies the terminal 12 of an alarm to prompt speed reduction (19). Alternatively, when the location is in the restricted area and the speed does not exceed the threshold (Yes in 18), the management apparatus 6 notifies the terminal 12 of an alarm to inform the user that there is a speed limit (19).

When the location is not in the restricted area (No in 18), the management apparatus 6 determines whether the location of the movable object 10 is in the prohibited area (20). When the location is in the prohibited area (Yes in 20), the management apparatus 6 notifies the terminal 12 of an alarm to promote exit from the prohibited area. When the location is outside of the prohibited area (No in 20), the management apparatus 6 returns the process to 11, and waits for the arrival of the next owner code and location information.

In each of the process 19 and the process 21, the management apparatus 6 may transmit the control information for the movable object 10 to the radio communication apparatus (UE). For example, in the process 19, the management apparatus 6 sends control information to reduce the travelling speed of the movable object 10. Alternatively, in the process 21, the management apparatus 6 sends control information to move the movable object 10 in a direction away from the prohibited area. The control unit of the movable object 10 controls at least one of the power source and the propeller in accordance with the control information received by the radio communication apparatus (UE), and reduces the speed or changes the propulsion direction and the propulsion altitude.

When the location of the movable object 10 is unknown due to a loss of control of the movable object 10, the user of the movable object 10 may send an inquiry to the management apparatus 6, and may search the movable object 10 based on the history of location information (flight record) stored in the DB 7.

In the first embodiment, the network system which is operable as the movable object management system includes the base station 1 which performs radio communication with the radio communication apparatus (UE). Further, the network system includes the management apparatus 6 (one example of “control unit”) that determines whether or not the movable object 10 is present in the area associated with the regulation on the movable object 10, based on the location information of the movable object 10 received from the radio communication apparatus (UE) via the base station 1. The start-up or movement of the movable object may be regulated using the determination result indicating whether or not the movable object is present in the area associated with the regulation based on the location information of the movable object. That is, the movement of the movable object may be regulated based on the location information of the movable object.

When the movable object 10 is not present in an area associated with the movable object 10, for example, in a regulated area, the management apparatus 6 transmits the information for releasing the movement regulation (e.g., locking of the power source and the propeller) of the movable object 10 to the designated address (movable object 10). Accordingly, the movement of the movable object outside the regulated area is permitted and locking in the regulated area is not released, thereby making it possible to prohibit the movement of the movable object 10 in the regulated area.

When the movable object 10 is present in the area associated with the regulation (for example, the regulated area, the restricted area, or the alarm notification area), the management apparatus 6 transmits an alarm to the designated address (for example, the terminal 12 of the user). This makes it possible to inform the user of the movable object 10 that the location of the movable object 10 is in the regulated area, the restricted area, or the peripheral area of the restricted area and the regulated area, thereby causing the movable object 10 to refrain from flying.

When the movable object 10 is present in an area associated with regulations (for example, the regulated area or the restricted area), the management apparatus 6 transmits movement control information for the movable object 10 (for example, control information for changing the destination spot of the movable object 10, and control information for reducing the speed of the movable object 10) to the designated address. The designated address is, for example, the movable object 10. This enables the movable object 10 to be moved to the outside of the regulated area, or to reduce the speed of the movable object 10 within the restricted area to a restricted speed or less.

The base station 1 receives the location information of the movable object 10 transmitted from the radio communication apparatus (UE) included in the movable object 10. When the movable object 10 performs a location measurement using a GPS for automatic operation, a configuration in which the movable object 10 is mounted with a UE function to send the location information from the movable object 10 to the base station 1 may be easily employed.

Further, according to the first embodiment, the user of the movable object 10 may be informed that there is a possibility of contact with another movable object.

### Second Embodiment

Next, a second embodiment will be described. The second embodiment has features common to those of the first embodiment. Accordingly, differences between the first and second embodiments will be mainly described, and the descriptions of the common features will be omitted.

### <Configuration of Base Station>

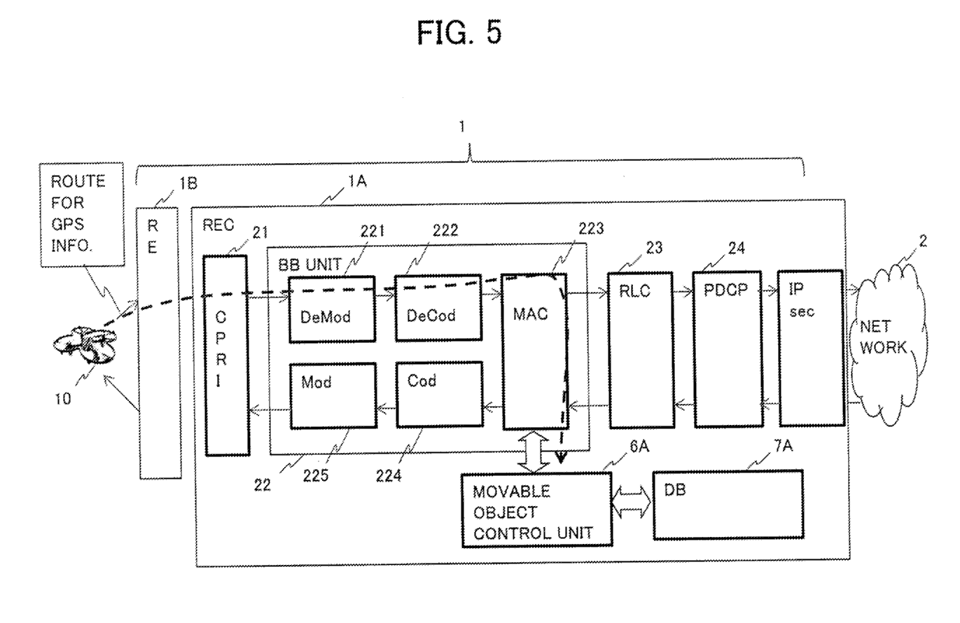

FIG. 5 is a diagram illustrating a configuration example of the base station 1 according to the second embodiment. The base station 1 includes a radio control device (Radio Equipment Control (REC) LA) and a radio device (Radio Equipment (RE)) 1B that is connected to the REC 1A and forms a cell. The REC 1A and the RE 1B are connected by a link using a Common Public Radio Interface (CPRI) which is one of standard specifications of the internal interface of the base station. However, it is not an indispensable configuration requirement that the base station 1 is formed of an REC and an RE.

The RE 1B includes an RF circuit and a transmission/reception antenna which transmit and receive a radio signal (RF signal), and performs radio communication with the radio terminal (UE). The RE 1B converts a baseband signal (BB signal), which is obtained by a process of converting the RF signal received by the transmission/reception antenna, into a signal format (CPRI signal) in accordance with CPRI, and sends the CPRI signal to the REC 1A. Further, the RE 1B converts the CPRI signal received from the REC 1A into a BB signal, converts the BB signal into an RF signal, and radiates the RF signal from the transmission/reception antenna.

The REC 1A includes a CPRI interface 21, a base band (BB) unit 22, an RLC (Radio Link Control) processing unit 23, a PDCP (Packet Data Convergence Control) processing unit 24, and an IPsec (Security Architecture for Internet Protocol) processing unit 25. The REC 1A also includes a movable object control unit 6A and a database (DB) 7A.

The CPRI interface 21 converts the CPRI signal received from the RE 1B into a BB signal. The BB unit 22 includes a demodulator (DeMod) 221, a decoder (DeCod) 222, a MAC (Media Access Control) processing unit 223, an encoder (Cod) 224, and a modulator (Mod) 225.

The demodulator 221 demodulates the BB signal from the CPRI interface 21, and the decoder decodes the demodulation signal, thereby obtaining data. The encoder 224 encodes the data, and the modulator 225 modulates the encoded data and generates the BB signal.

The radio protocol between the base station 1 and the UE includes Layer 1 (physical layer: PHY) and Layer 2. The PHY performs processes such as data coding/decoding, modulation/demodulation, and antenna multiplexing. The demodulator 221, the decoder 222, the encoder 224, and the modulator 225 control the process of the PHY layer.

Layer 2 includes sub-layers MAC, RLC, and PDCP. In the MAC layer, radio resource allocation, data mapping, retransmission control, and the like are carried out. In the RLC, retransmission control, duplicate detection, lining-up, and the like are carried out. In the PDCP, compression of an IP packet head, reply, and encryption are carried out.

The MAC processing unit 223 performs the process of the MAC layer. The RLC processing unit 23 performs the process of the RLC layer. The PDCP processing unit 24 performs the process of the PDCP layer. The IP sec processing unit 25 performs an IP sec process related to encryption of IP packets. IP packets (user data) for the network 2 are transmitted using UDP and GPT-U.

### <Protocol Stack>

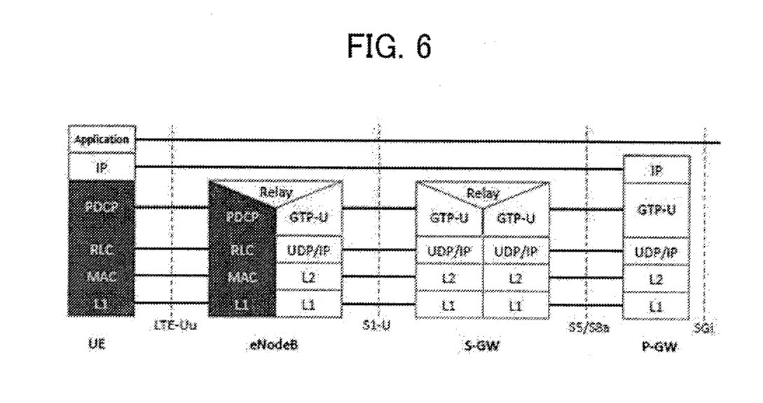

FIG. 6 is an explanatory diagram illustrating a protocol stack in a user plane of LTE. Referring to FIG. 6, a UE and a base station (eNodeB) are connected with an LTE-Uu interface, and the UE and the base station are connected with a plurality of protocols L1 (PHY), MAC, RLC, and PDCP (referred to as a “first protocol stack”) in order from the lowermost layer. An IP and an application are provided in an upper layer of the PCCP, and the IP is connected by the P-GW 5.

The base station (eNodeB) and the S-GW4 are connected with an S1-U interface using a plurality of protocols L1, L2, UDP/IP, and GTP-U (referred to as a “second protocol stack”). The IP sec processing unit 25 illustrates one example of the process of layers higher than Layer 2 that is performed by the REC 1A. Through the processes of the IP sec processing unit 25 and the UDP and GTP-U (not illustrated), the IP packets are transferred to the S-GW4 with a GTP tunnel based on the GTP-U. The above-described processes are carried out in an upward direction (UE→network), while processes opposite to the processes are carried out in a downward direction (network→UE).

### <Control Unit>

Referring again to FIG. 5, the REC 1A includes the movable object control unit 6A and the DB 7A. The control unit 6A performs an operation similar to that of the management apparatus 6 of the first embodiment, and the DB 7A stores information similar to the information included in the DB 7 of the first embodiment. Thus, in the second embodiment, the management apparatus 6 (which is one example of the determine device) and the DB 7 are included (provided) in the base station 1. As the base station 1 of the first embodiment, the base station 1 which is formed of the RE 1B and the REC 1A as illustrated in FIG. 5 may be applied. In the first embodiment, the control unit 6A and the DB 7A may be omitted.

### <MAC PDU>

In the second embodiment, the radio communication apparatus (UE) is mounted on the movable object 10, and the location information of the movable object 10 is mapped on a MAC SDU (MAC Service Data Unit) which is a data block to be treated in the MAC layer. When the value of a specific LCID is set in a MAC header, the MAC processing unit 223 extracts the location information of the movable object 10 stored in the MAC SDU corresponding to the LCID, and supplies the extracted location information to the control unit 6A. The control unit 6A performs a process similar to that of the management apparatus 6 by using the location information and the information (including map information) stored in the DB 7A.

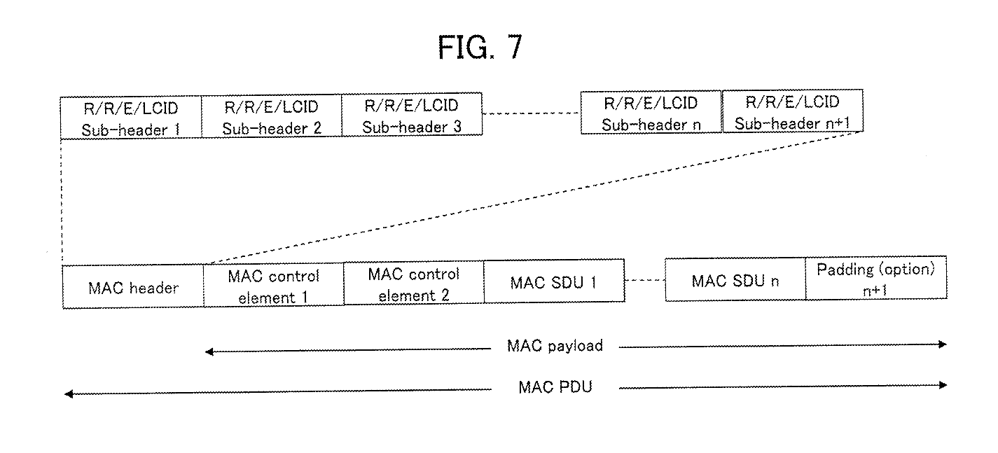

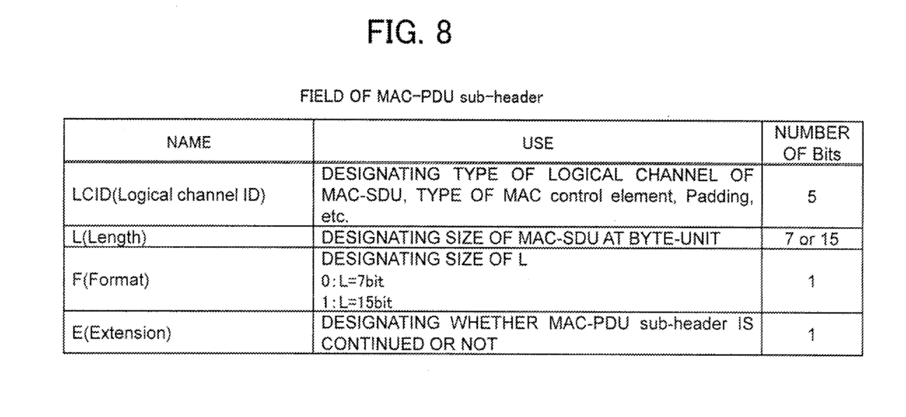

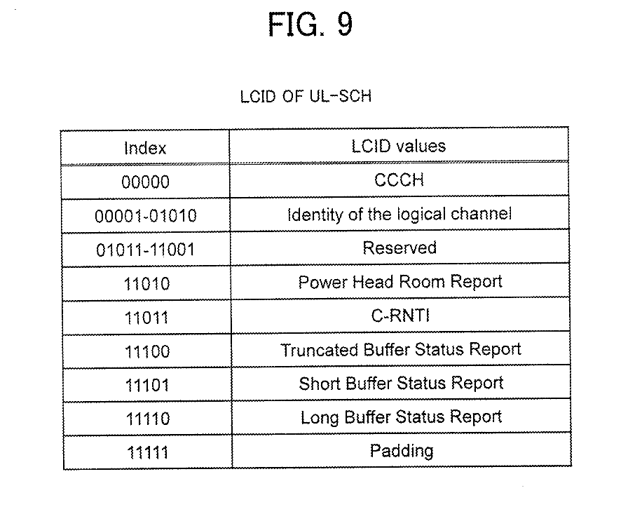

FIG. 7 is an explanatory diagram illustrating a MAC PDU (MAC Protocol Data Unit). FIG. 8 is a table illustrating a MAC header. FIG. 9 is a table illustrating values of an LCID (Logical Channel identifier) of a UL-SCH (Uplink-Shared Channel).

In the second embodiment, GPS information (location information of the movable object 10) is transferred to the base station 1 via the UL-SCH. The MAC PDU of the UL-SCH is formed of a MAC header and a MAC payload as illustrated in FIG. 7. The MAC header is formed of zero or one or more MAC PDU sub-headers. The MAC payload is formed of zero or one or more MAC control elements and/or the MAC SDU. When the size of the MAC PDU is less than the allocated transport block (TB) size, padding is inserted.

Each MAC SDU is associated with one MAC PDU sub-header in the MAC header. As illustrated in FIG. 8, the MAC PDU sub-header includes identifiers of LCID, L (length), F (format), and E (extension).

The LCID is used to designate the type of the logical channel of the MAC SDU, the type of the MAC control element, and padding. As illustrated in FIG. 9, the LCID is a 5-bit field, and “00001” to “01010” are used to identify the logical channel. The second embodiment illustrates an example in which any one of “Reserved” values (“01011” to “11001”) (referred to as a special LCID value), the application of which has not been determined, is used as an identifier indicating that the corresponding MAC SDU includes location information.

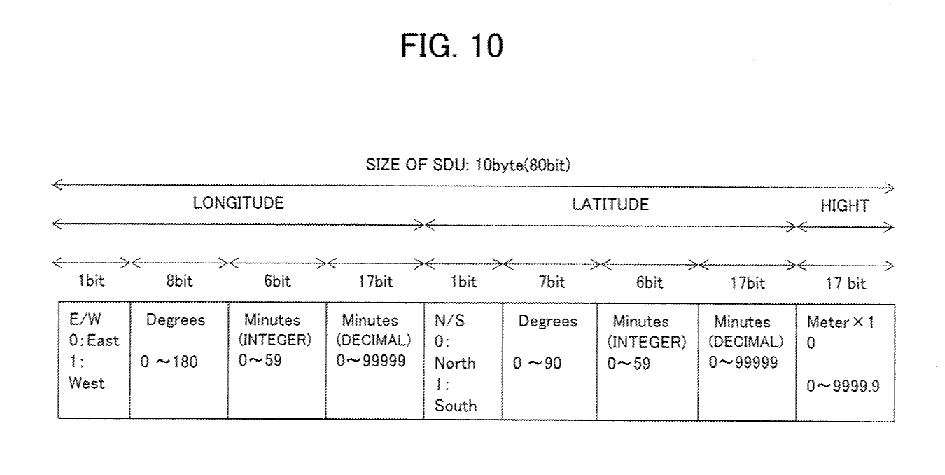

FIG. 10 illustrates an example of mapping of location information on the MAC SDU. The MAC SDU is a 10-byte (80-bit) field. As illustrated in FIG. 10, a longitude, a latitude, and a height (altitude) are set.

The user identification information (owner code) described in the first embodiment is also stored in the MAC SDU, and the special LCID value is set in the corresponding MAC PDU sub-header. The location information of the movable object 10 and the location information of the input apparatus 11 may be stored in different MAC SDUs and received by the base station 1. Also in this case, the special LCID value is set in the MAC PDU sub-header corresponding to each MAC SDU. As the special LCID value, a special LCID value common to a set of the location information and owner code of the movable object 10 and the location information of the input apparatus may be set, or different special LCID values may be set. Alternatively, different special LCID values may be used depending on the type of information (location information and owner code of the movable object 10 and location information of the input apparatus).

### <Hardware Configuration of Base Station (REC)>

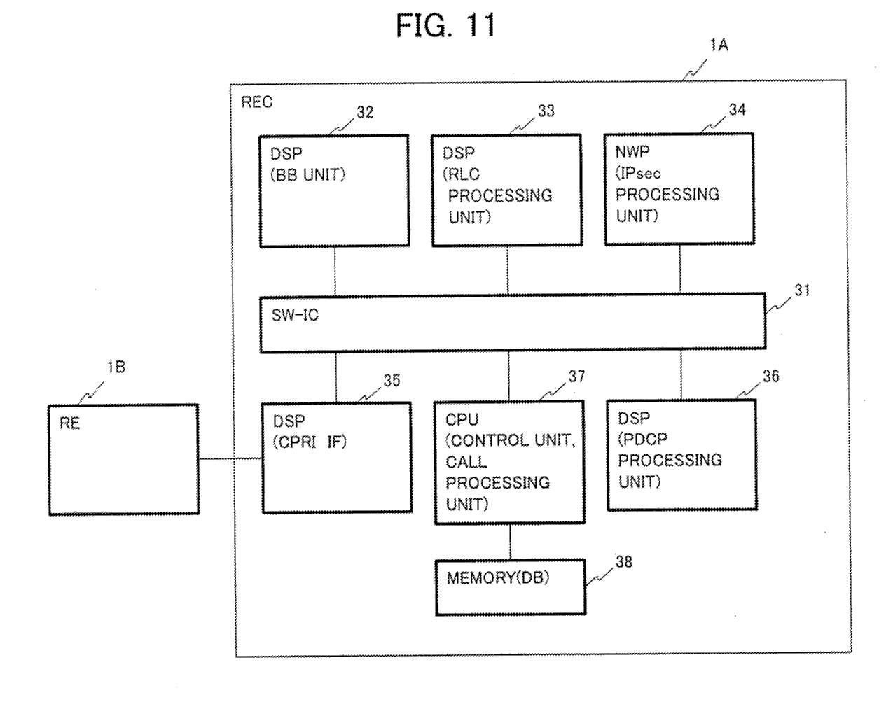

FIG. 11 is a diagram illustrating a hardware configuration example of the REC 1A. The REC 1A includes: an integrated circuit (SW-IC) 31 that operates as a switch; Digital Signal Processors (DSPs) 32 to 36 that are connected to the SW-IC; a CPU 37; and a memory 38 that is connected to the CPU 37.

The DSP 32 operates as a BB unit 22 (MAC processing unit 223) illustrated in FIG. 5. The DSP 33 operates as an RLC processing unit 23 illustrated in FIG. 5. The DSP 36 operates as the PDCP processing unit 24 illustrated in FIG. 5. The DSP 35 operates as the CPRI interface (CPRI IF) illustrated in FIG. 5.

The memory 38 including the main storage device 62 and the auxiliary storage device 63 has been described above with reference to FIG. 2. The CPU 37 executes the program stored in the memory 38, thereby performing the call process (process of connecting the UE to the network) and the process as the control unit 6A. The memory 38 stores the DB 7A.

A plurality of DSPs 32 to 36 are provided in the example illustrated in FIG. 11, but a plurality of layer processes may be carried out in one DSP. Instead of using the DSPs 32 to 36, a programmable logic device (PLD) such as a Field Programmable Gate Array (FPGA), or an integrated circuit (LSI, Application Specific Integrated Circuit (ASIC), etc.) other than the PLD and FPGA may be applied. At least a part of the process performed in the CPU 37 may be performed by the integrated circuit.

Each of the CPU 37 and the DSPs 32 to 36 is one example of a “processor”, a “control unit”, a “controller”, and a “control device”. The memory 38 is one example of a “memory”, a “storage device”, and a “computer-readable storage medium”.

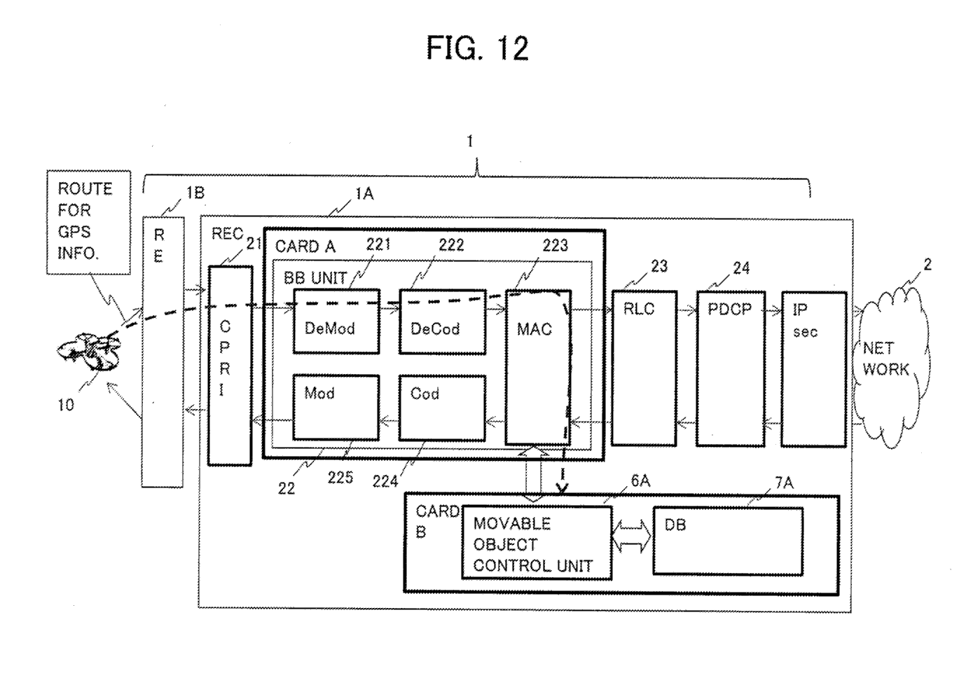

FIGS. 12, 13, and 14 illustrate other configuration examples of the base station 1 (REC 1A). As illustrated in FIG. 12, the REC 1A may be formed of a chassis-type device. The chassis-type device includes a chassis having a plurality of slots, and a card is inserted into each slot.

The card is a device having a plate-like appearance configuration, at least one of modules, such as an electronic component, an electronic device, an integrated circuit, and a physical device for executing a desired function or process is mounted. The card is also called a “function card”. The card may be called a “panel”, “board”, “packet”, “PIU (Plug In Unit)”, or the like.

The chassis includes a backbone switch that electrically connects the card to be inserted into each slot. FIG. 12 illustrates an example in which the BB unit 22 is mounted on a certain card (card A) and the control units 6A and DB 7A are mounted on a card B different from the card A. By inserting or removing the card B into or from the chassis (slot), a function for performing control (management) for the movable object 10 may be provided to the base station 1 or removed therefrom.

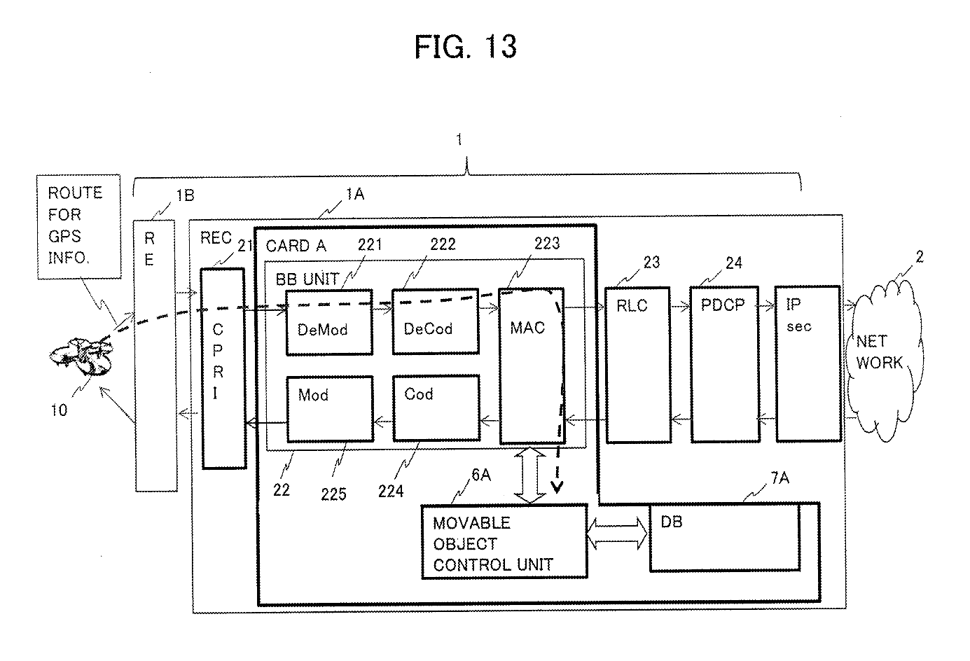

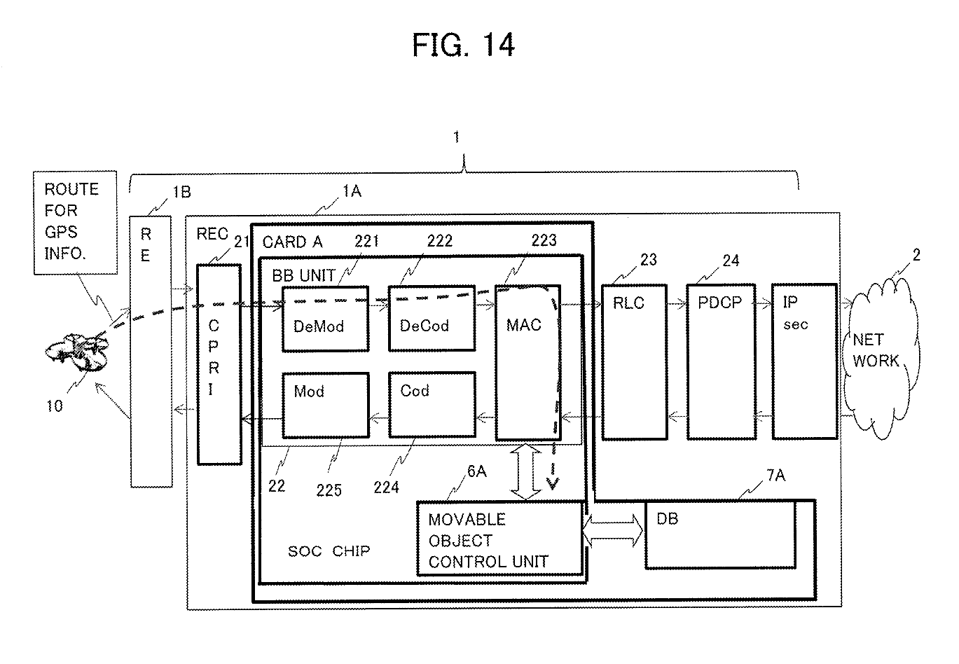

FIG. 13 illustrates an example in which the BB unit 22, the control unit 6A, and the DB 7A are mounted on the same card (card A). In this case, a transmission delay in the device may be reduced. As illustrated in FIG. 14, the BB unit 22 and the control unit 6A may be integrated on one (a single) semiconductor chip by using an SOC technique and mounted like a card. For example, the functions of the BB unit 22 and the control unit 6A may be implemented by an SOC chip having a configuration in which a DSP core and a CPU core are integrated on one (a single) semiconductor chip. In this case, the number of components of the base station 1 may be reduced. The delay time in the base station 1 (REC 1A) may be reduced in the order of the configuration of FIG. 12, the configuration of FIG. 13, and the configuration of FIG. 14.

### <Method for Transmitting Location Information of Movable Object 10>

Examples of the method for transmitting the location information of the movable object 10 to the base station 1 include the following Methods 1 to 3.

### <<Method 1>>

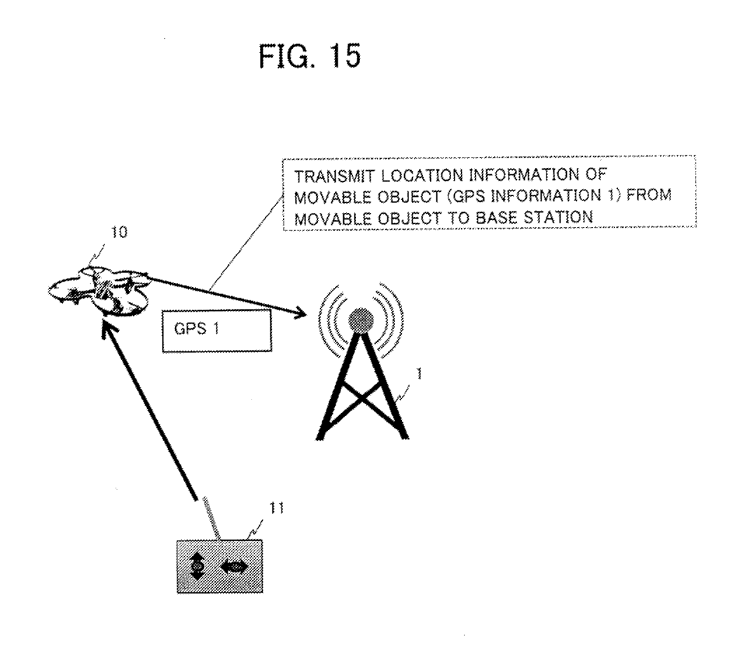

FIG. 15 is an explanatory diagram illustrating Method 1. In Method 1, the movable object 10 includes the components of the radio communication apparatus (UE) and the GPS receiver. The movable object 10 acquires location information (position coordinate: which is also called GPS information) using the GPS receiver, and transmits the location information to the base station 1 (network) using the UE function.

### (Hardware Configuration of Movable Object According to Method 1)

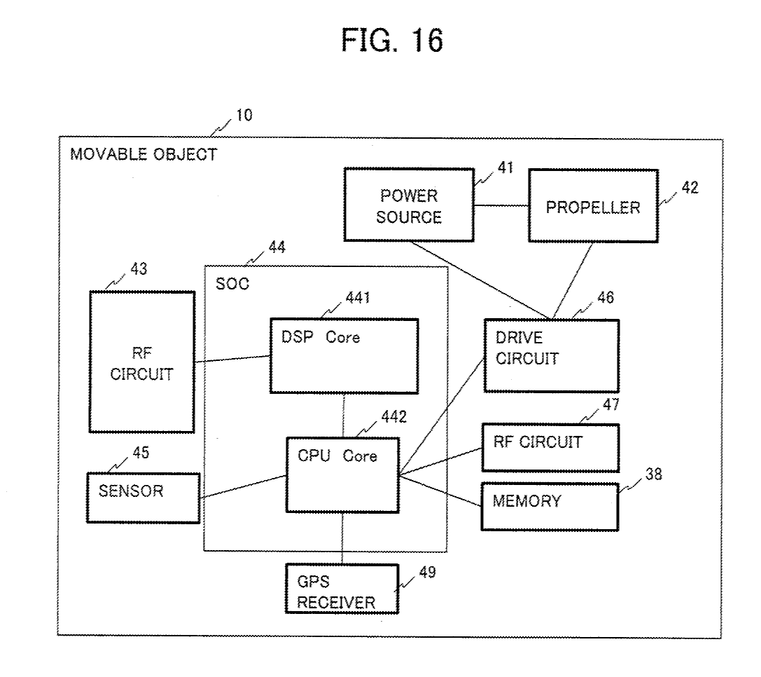

FIG. 16 illustrates a hardware configuration example of the movable object 10 corresponding to Method 1. Referring to FIG. 16, the movable object 10 includes a power source 41, a propeller 42, an RF circuit 43, a System-on-a-chip (SOC) chip 44, a sensor 45, a drive circuit 46, an RF circuit 47, a memory 38, and a GPS receiver 49. Each of the RF circuit 43 and the SOC chip 44 is one example of the “radio communication apparatus” (UE).

The power source 41 is, for example, a motor. The power source 41 may be a reciprocating engine. In this embodiment, the propeller 42 is, for example, a plurality of rotors. The drive circuit 46 transmits power from the power source 41 to the propeller 42 (each rotor), and adjusts the rotation speed and the like of each rotor in accordance with a control signal from the SOC chip 44 (CPU core 442). The posture in the air of the movable object 10, the flight speed thereof, and the like are adjusted by controlling the rotation speed and the like.

The SOC chip 44 is an integrated circuit having a configuration in which desired functions are integrated on one (a single) semiconductor chip. The SOC chip 44 includes a DSP core 441 and a CPU core 442. The DSP core 441 includes a BB unit that allows the movable object 10 to function as a radio communication apparatus (UE), and functions as an RLC processing unit and a PDCP processing unit.

The DSP core 441 is connected to the RF circuit 43 for communicating with the base station 1. The RF circuit 43 performs a process of conversion between a base band (BB) signal and a radio signal. The RF circuit 43 is connected to a transmission/reception antenna (not illustrated). The transmission/reception antenna transmits and receives radio signals (radio waves).

The CPU core 442 executes the program stored in the memory 38, thereby performing the call process and the processes for the IP layer and the application layer (FIG. 6) so that the movable object 10 functions as the UE. Further, the CPU core 442 operates as the control unit for movement (flight) of the movable object 10 by executing the program. The memory 38 includes the main storage device and the auxiliary storage device as described above, and stores programs and data. The memory 38 may be included in the SOC chip 44.

The GPS receiver 49 receives a signal from the GPS satellite, measures the time and position coordinate (location information), and inputs them to the CPU core 442. The sensor 45 includes various sensors such as a gyroscopic sensor and an acceleration sensor. Various physical amounts detected by sensors are supplied to the CPU core 442, and are used for automatic manipulation of the movable object 10 by the CPU core 442. The RF circuit 47 performs radio communication with the input apparatus 11.

### (Hardware Configuration of Input Apparatus 11 of Method 1)

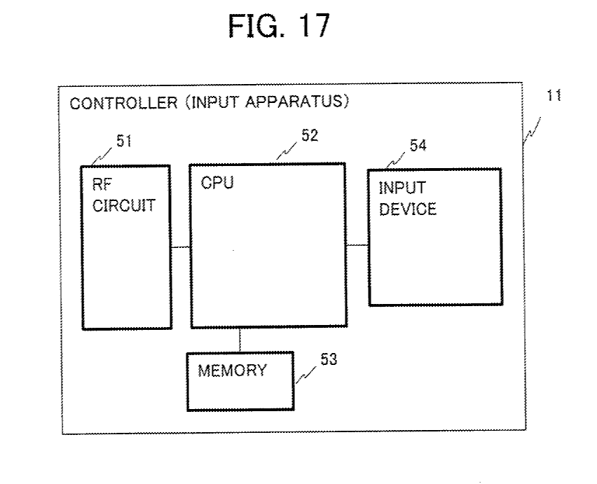

FIG. 17 is a diagram illustrating a hardware configuration example of the input apparatus 11. The input apparatus 11 includes an RF circuit 51, a CPU 52, a memory 53, and an input device 54. The input device 54 used for the user to input control information for the movable object 10. The input device 54 includes entry devices such as a switch, buttons, keys, a lever, a dial, and a touch panel.

The CPU 52 executes the program stored in the memory 53, thereby performing the following process. The CPU 52 transmits the control information of the movable object, which is input by the input device 54, to the RF circuit. The RF circuit 51 performs radio communication with the movable object 10, and transmits the control information to the movable object 10. The radio communication between the movable object 10 and the input apparatus 11 may be unidirectional or bidirectional.

Each of the SOC chip 44, the CPU 52, and the SOC chip 57 is one example of a “processor”, a “control unit”, a “controller”, and a “control device”. Each of the memory 38 and the memory 53 is one example of a “memory”, a “storage device”, and a “computer-readable storage medium”.

### <<Method 2>>

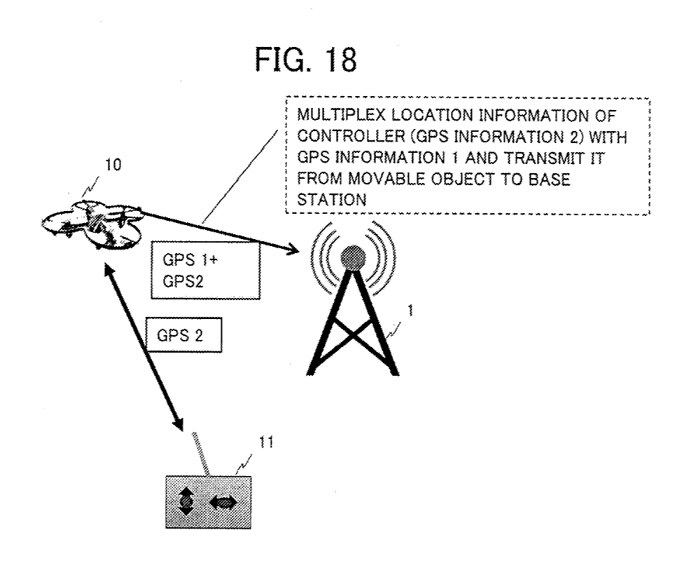

FIG. 18 is an explanatory diagram illustrating Method 2. In Method 2, the movable object 10 includes components of the radio communication apparatus (UE) and a GPS receiver. The input apparatus 11 also includes a GPS receiver and obtains location information (GPS information 2) of the input apparatus 11. The GPS information 2 is transmitted to the movable object 10 by radio communication. The movable object 10 transmits the location information (GPS information 1) of the movable object 10 and the GPS information 2 to the base station 1 (network).

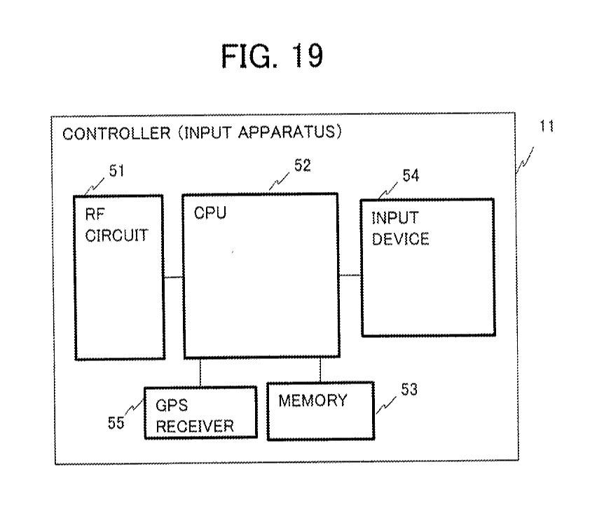

As the hardware configuration of the movable object 10 that may be used in Method 2, the same configuration as that of Method 1 illustrated in FIG. 16 may be applied. Accordingly, the description of the hardware configuration is omitted. FIG. 19 illustrates a hardware configuration example of the input apparatus 11 which may be used in Method 2.

As illustrated in FIG. 19, the input apparatus 11 includes a GPS receiver 55 in addition to the components illustrated in FIG. 17. The GPS receiver measures the location information (position coordinate: GPS information 2) of the input apparatus 11. The CPU 52 executes the program stored in the memory 53, and transmits the location information of the input apparatus 11 from the RF circuit 51 to the movable object 10. The input apparatus 11 may periodically transmit the GPS information 2 to the movable object 10. Alternatively, the location information may be returned in response to an inquiry (polling) from the movable object 10.

In the movable object 10, the RF circuit 47 receives location information. The DSP core 441 of the movable object maps, on the MAC SDU, the location information (GPS information 2) of the input apparatus 11, the location information (GPS information 1) of the movable object 10 obtained from the GPS receiver 49, and the owner code (which is preliminarily stored in the memory 38). The DSP core 441 generates a BB signal including the MAC PDU including the MAC PDU sub-header (including a special LCID value) corresponding to each MAC SDU by coding and modulation. The RF circuit 43 converts the BB signal generated by the DSP core 441 into an RF signal, and transmits the RF signal to the base station 1.

### <<Method 3>>

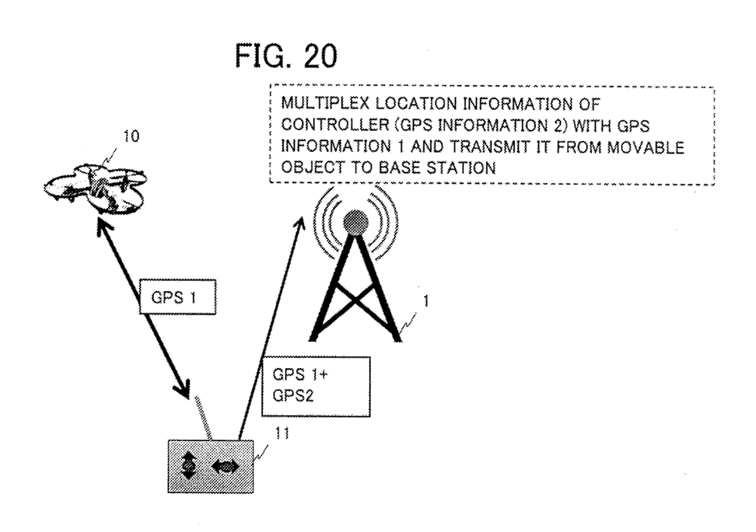

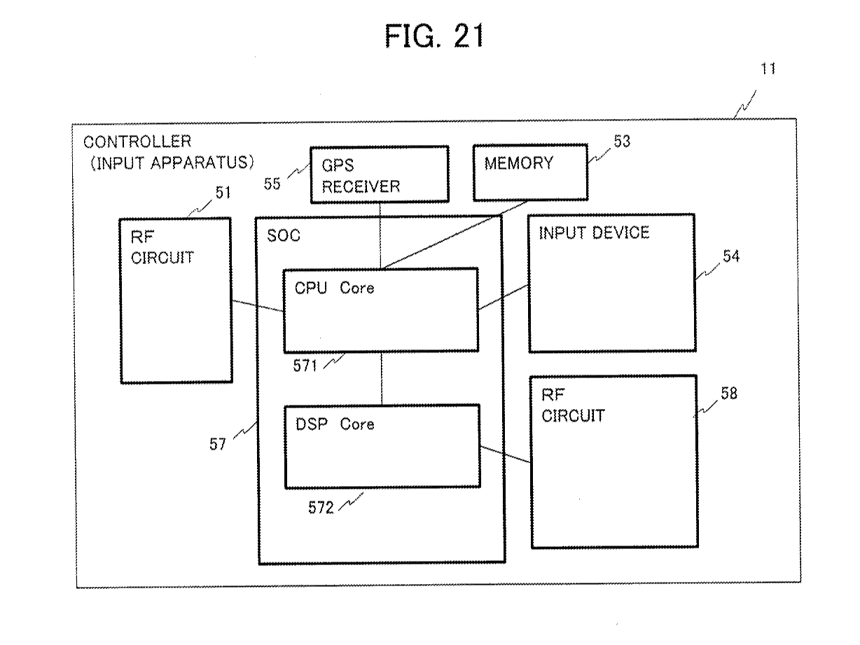

FIG. 20 is an explanatory diagram illustrating Method 3. FIG. 21 illustrates a configuration example of the input apparatus 11 which is used in Method 3. As the movable object 10 to which Method 3 is applied, for example, the configuration of the movable object 10 illustrated in FIG. 16 may be applied. However, in Method 3, the movable object 10 need not necessarily include the components of the radio communication apparatus (UE). The movable object 10 includes a GPS receiver 49, and transmits the location information (GPS information 1) of the movable object 10 to the input apparatus 11 by radio communication.

As illustrated in FIG. 21, the input apparatus 11 includes the configuration (second radio device) of the UE. Specifically, the input apparatus 11 includes the SOC chip 57 instead of the CPU 52, and an RF circuit 58 for performing radio communication with the base station 1. The input apparatus 11 has the same configuration as that of the input apparatus 11 illustrated in FIG. 19, except for these components. The RF circuit 51 receives the GPS information 1 from the movable object 10. The SOC chip 57 includes a CPU core 571 and a DSP core 572. The CPU core 571 performs a call process (process of connecting to the network via the base station 1 as the UE).

The DSP core 572 operates as the BB unit, the RLC processing unit, and the PDCP processing unit. The DSP core 572 generates the MAC PDU including the MAC SDU on which the GPS information 1, the GPS information 2, and the owner code are mapped and the MAC PDU sub-header corresponding to each MAC SDU. The DSP core 572 generates a BB signal including the MAC PDU, and inputs the BB signal to the RF circuit 58. The RF circuit 58 converts the BB signal into an RF signal, and transmits the RF signal to the base station 1. The configurations according to Methods 1 to 3 may also be applied to the first embodiment.

### <Processing Example>

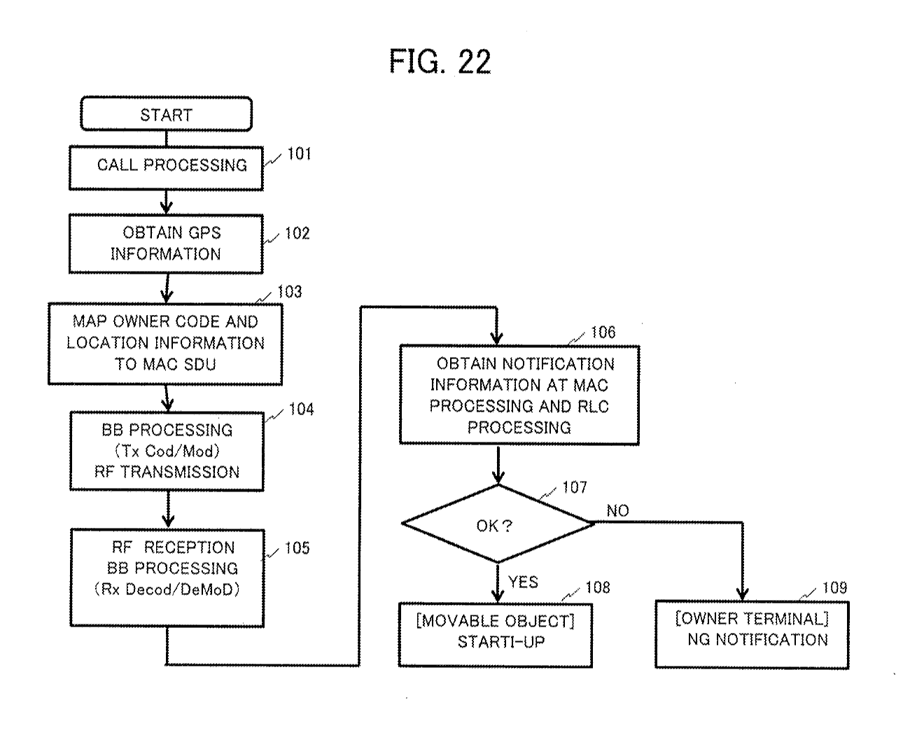

FIG. 22 is a flowchart illustrating a processing example during start-up of the movable object 10. The process illustrated in FIG. 22 is carried out by the CPU core 442 included in the movable object 10 in accordance with Method 1. In 101, the movable object 10 (CPU core 442) performs a call process. Specifically, the movable object 10 performs radio connection with the base station 1 as the UE, and is connected to the network via the base station 1.

In 102, the CPU core 442 acquires location information (position coordinate: GPS information 1) of the movable object 10 that is obtained by the GPS receiver 49. In 103, the CPU core 442 maps, on the MAC SDU, an owner code (user's identification information) stored in advance in the memory 38 and GPS information 1, thereby generating the MAC PDU.

In 104, the BB process (coding and modulation) by the DSP core 441 and the RF signal transmission process by the RF circuit 43 are carried out. The base station 1 receives the RF signal from the movable object 10. In 105, the RF signal which is supplied from the base station 1 and includes a response (notification information) corresponding to the location information and owner code is received, and a BB process (demodulation and decoding) is carried out (105).

The CPU core 442 performs a MAC process and an RLC process for the data obtained by the BB process, and acquires the notification information from the base station 1 (106). In 107, the CPU core 442 determines whether or not the notification information indicates that start-up of the movable object 10 is OK. When the notification information indicates that start-up is OK (Yes in 107), the CPU core 442 releases locking (drive prohibition) of the OFF state of each of the power source and the propeller of the movable object 10. When the notification information indicates that start-up is NG, the CPU core 442 notifies the terminal 12 that start-up is NG. The notification may be any one of a telephone call (automatic audio), an e-mail, a short mail, and the like for the terminal 12.

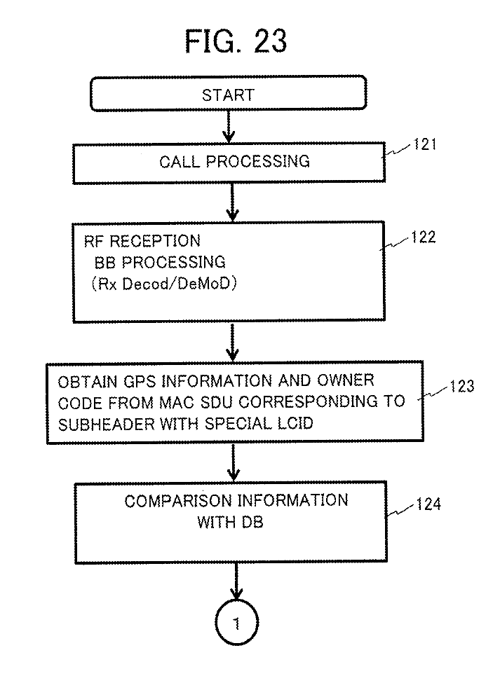

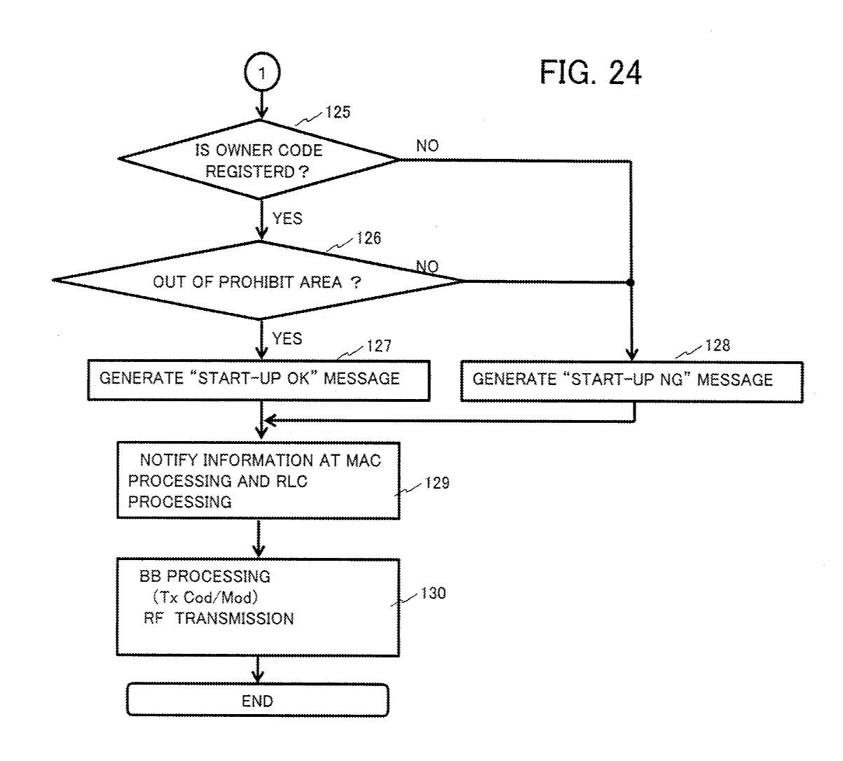

FIGS. 23 and 24 are flowcharts each illustrating a processing example of the base station 1. Referring to FIG. 23, the base station 1 performs a call process related to the movable object 10 (121). By the call process, the movable object 10 (radio communication apparatus (UE)) is connected (registered) to the network via the base station 1, the communication path (bearer) between the movable object 10 and the network is established.

In 122, the base station 1 receives the RF signal from the movable object 10, performs a process (BB process: demodulation, decoding, etc.) on the BB signal converted from the RF signal, thereby obtaining the MAC PDU. In 123, the DSP 32 (MAC processing unit 223) determines whether or not a special LCID value is set in a MAC PDU sub-header, extracts the location information (GPS information) and the owner code stored in the MAC SDU corresponding to the MAC PDU sub-header in which the special LCID value is set, and supplies the extracted location information to the CPU 37 (control unit 6A).

In 124, the CPU 37 (control unit 6A) starts the process of comparing the owner code and location information with the DB 7A. In 125, the CPU 37 determines whether or not the owner code is registered. In the process 125, for example, the CPU 37 tries to readout information corresponding to the owner code from the DB 7A. Reading out information means that the owner code is registered, and not reading out information means that the owner code is not registered.

When the information corresponding to the owner code is not read out from the DB 7A (No in 125), the process proceeds to 128. On the other hand, when the information corresponding to the owner code is read out from the DB 7A (Yes in 125), the process proceeds to 126.

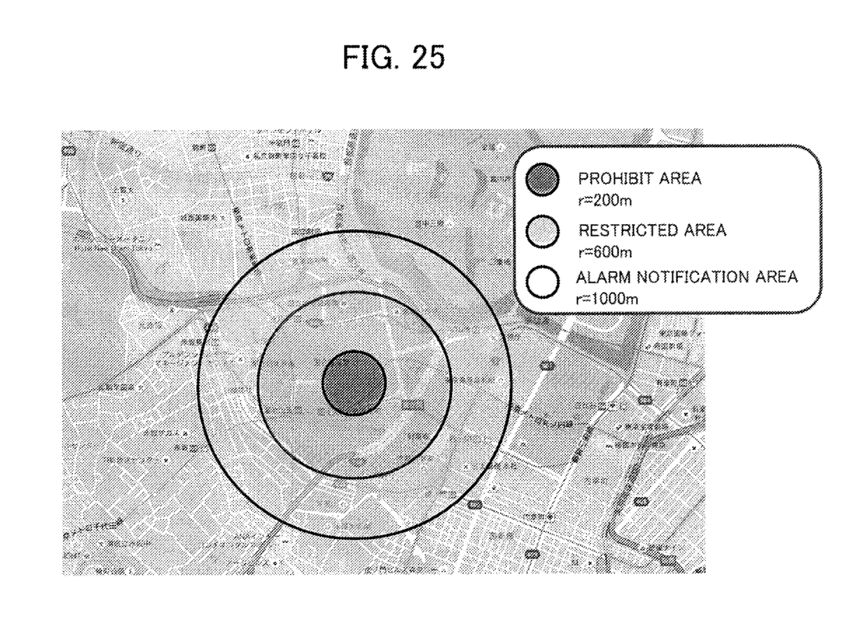

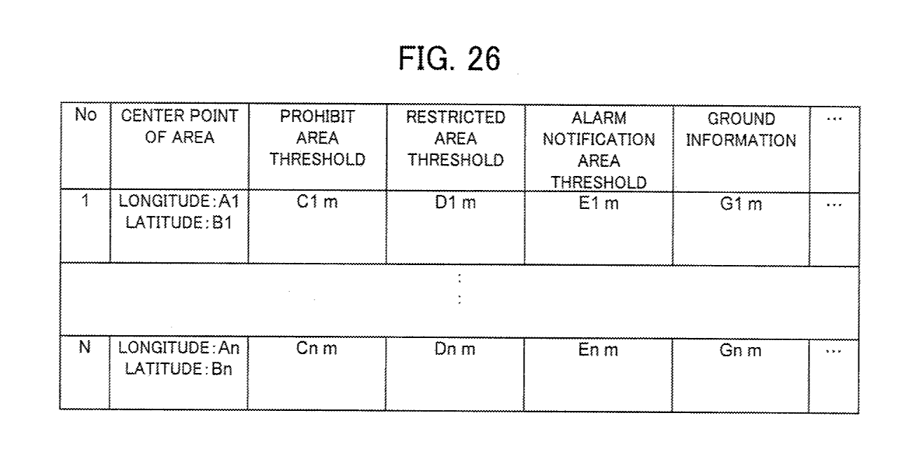

FIGS. 25 and 26 illustrate an example of information stored in the DB 7A in such a manner that the information is associated with the owner code. For example, the DB 7A stores map information of the prohibited area, the restricted area, and the alarm notification area as illustrated in FIG. 25. In the example illustrated in FIG. 25, the prohibited area, the restricted area, and the alarm notification area are defined in order from the innermost side in a concentric fashion about a certain main location. The prohibited area, the restricted area, and the alarm notification area have been described in the first embodiment. Accordingly, repeated explanation thereof is omitted.

In the DB 7A, the center point of the area, thresholds for the prohibited area, the restricted area, and the alarm notification area, and a threshold for surface elevation are preliminarily registered as illustrated in FIG. 26. In the example of FIG. 26, the thresholds are specified within a radius from the center of the area.

In 126, the CPU 37 compares the information about the prohibited area read out from the DB 7 with GPS information (location information of the movable object 10), and determines whether or not the movable object 10 is located outside of the prohibited area. The CPU 37 calculates the distance between the center coordinates of the prohibited area and the position coordinate of the movable object 10, and compares the distance with the threshold of the prohibited area. When the distance is smaller than the threshold, it indicates that the movable object 10 is present in the prohibited area, and when the distance is equal to or greater than the threshold, it indicates that the movable object is present outside the prohibited area.

When the location of the movable object 10 is outside the prohibited area (Yes in 126), the CPU 37 advances the process to 127. When the location of the movable object 10 is in the prohibited area (No in 126), the process proceeds to 128.

In 127, the CPU 37 generates, as notification information, a message (OK message) indicating that start-up of the movable object 10 is OK, and advances the process to 129. In 128, the CPU 37 generates, as notification information, a message (NG message) indicating that start-up of the movable object 10 is NG, and advances the process to 129.

In 129, the CPU 37 transmits the notification information (OK message or NG message) to, for example, the DSP (RLC processing unit 23). In 130, the OK message or NG message is mapped on the data block (RLC PDU) of the RLC, and performs the MAC process and the BB process in the DSP 32. The BB signal is transmitted to the RE 1B via the DSP 35 (CPRI IF), and is converted into an RF signal and transmitted to the movable object 10 (UE). Thus, a response (notification information) for the owner code and the GPS information is transmitted from the base station 1 to the movable object 10. The subsequent processes in the movable object 10 have been described above, and thus the descriptions thereof are omitted.

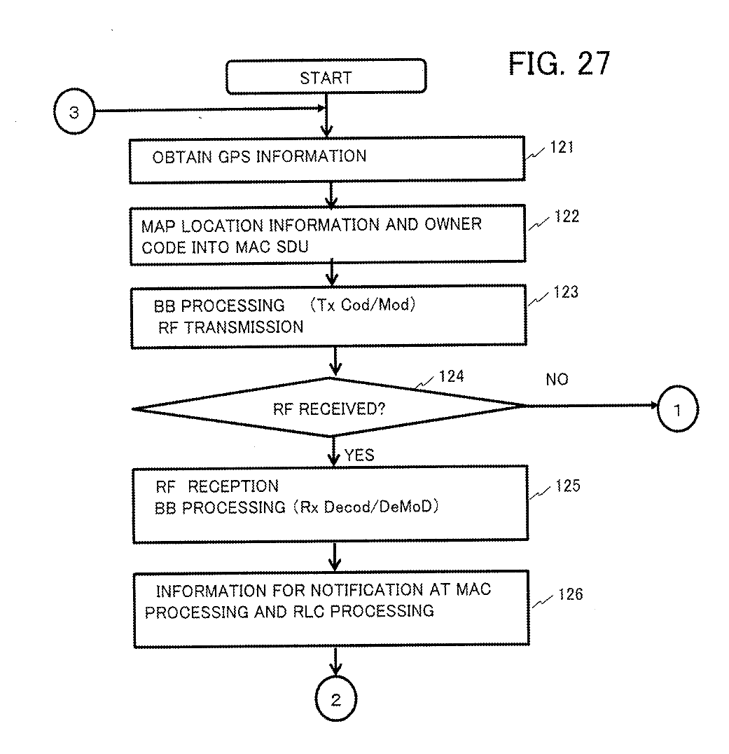

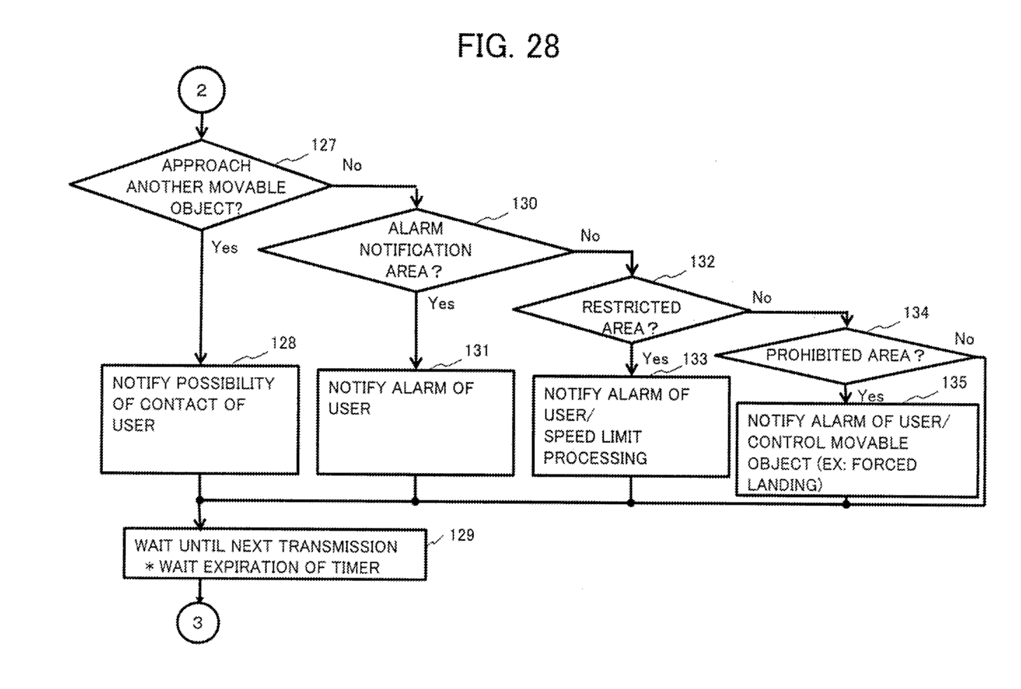

FIGS. 27 and 28 are flowcharts each illustrating a process in the movable object 10 after the start-up OK message is received. The processes 121 to 123 illustrated in FIG. 27 are the same as the processes 102 to 104 illustrated in FIG. 22, and thus the descriptions thereof are omitted. In 124, the movable object 10 determines whether or not the RF signal is received. When the RF signal is received (Yes in 124), the process proceeds to 125. When the RF signal is not received (No in 124), the process proceeds to 129. The processes 125 and 126 are the same as the processes 105 and 106 illustrated in FIG. 22, and thus the descriptions thereof are omitted.

In 127 of FIG. 28, the CPU core 442 determines whether or not the notification information obtained in 126 indicates the message “another movable object is approaching”. When the notification information indicates the message “another movable object is approaching” (Yes in 127), the process proceeds to 128. When the notification information does not correspond to the message indicating “another movable object is approaching” (No in 127), the process proceeds to 130.

In 128, the CPU core 442 notifies the user that there is a possibility of contact. For example, the CPU core 442 may notify the terminal 12 of the user of the possibility of a contact by telephone call, e-mail, or short mail. Alternatively, the movable object 10 causes the speaker included therein to output alarm sound, thereby making it possible to inform the user of the possibility of contact (near-miss (abnormal approaching)). A signal indicating the possibility of contact may be transmitted from the movable object 10 to the input apparatus 11, to thereby enable the input apparatus 11 to inform the user of the possibility of contact.

Like in Method 3, when the input apparatus 11 communicates with the base station 1, the input apparatus 11 receives a message such as the message “another movable object is approaching” from the base station 1. Upon receiving the message, the input apparatus 11 may notify the user of information indicating the content of the massage. The notification may be performed using sound, light, display of text and images, vibration, or a combination thereof.

In 130, the CPU core 442 determines whether or not the notification information obtained in 126 is a message “alarm notification area”. When the notification information indicates the message “alarm notification area” (Yes in 130), the process proceeds to 131. When the notification information does not indicate the message “alarm notification area” (No in 130), the process proceeds to 132. In 131, the CPU core 442 notifies the user of an alarm. As the notification method, the same method as that described in the process 128 may be applied. Accordingly, repeated explanation is omitted.

In 132, the CPU core 442 determines whether or not the notification information obtained in 126 corresponding to the message “restricted area”. When the notification information indicates the message “restricted area” (Yes in 132), the process proceeds to 133. When the notification information does not indicate the message “restricted area” (No in 132), the process proceeds to 134.

In 133, the CPU core 442 notifies the user of an alarm. As the notification method, the same method as that described in the process 128 may be applied. Accordingly, repeated explanation is omitted. In 133, a speed regulation process is performed on the movable object 10. Specifically, upon receiving the notification of the message “restricted area”, the CPU core 442 controls the drive circuit 46 to reduce the flight speed of the movable object 10.

In 134, the CPU core 442 determines whether or not the notification information obtained in 126 indicates the message “prohibited area”. When the notification information indicates the message “prohibited area” (Yes in 134), the process proceeds to 135. When the notification information does not indicate the message “prohibited area” (No in 134), the process proceeds to 129.

In 135, the CPU core 442 notifies the user of an alarm. As the notification method, the same method as that described in the process 128 may be applied. Accordingly, repeated explanation is omitted. In 133, the movable object 10 is controlled. Specifically, the CPU core 442 receives, from the base station 1 (control unit 6A), the message “prohibited area” and information about a destination spot (for example, a forced landing spot) outside of the prohibited area. In this case, the CPU core 442 controls the drive circuit 46 (propeller 42) so that the movable object 10 moves to the destination spot and lands on the destination spot. At this time, the CPU core 442 is in a state in which the CPU core does receive any information from the input apparatus 11.

In 129, the CPU core 442 starts the clock of a waiting time for waiting until the subsequent transmission timing of the location information. After completion of the timer, the process returns to 121.

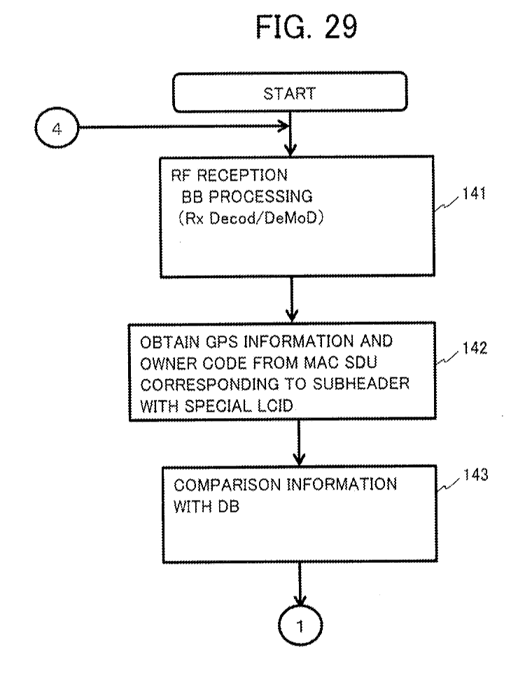

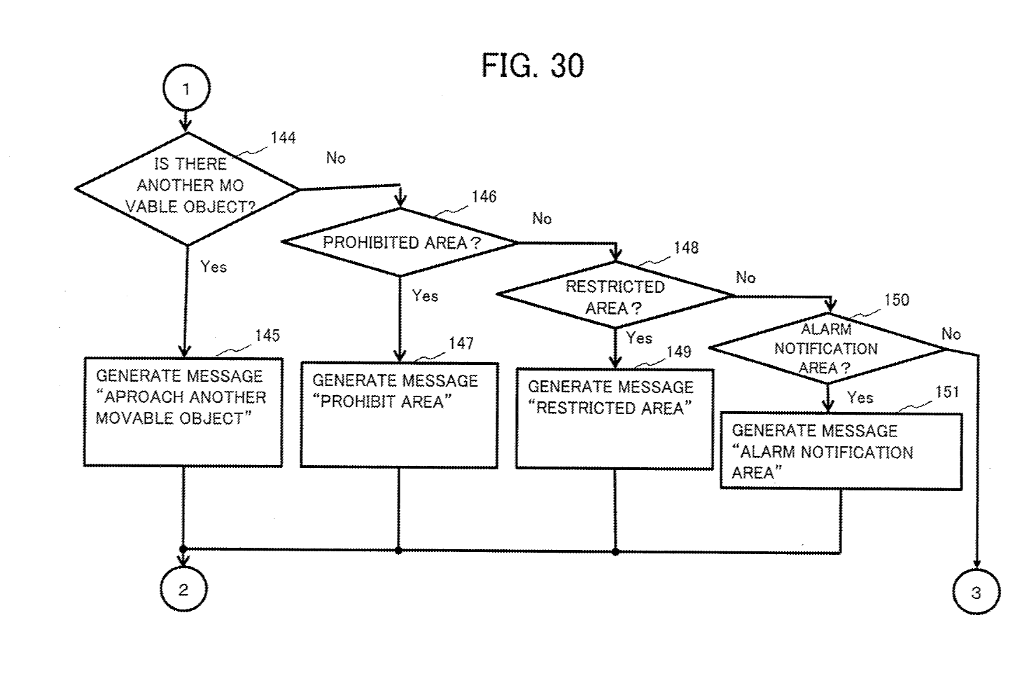

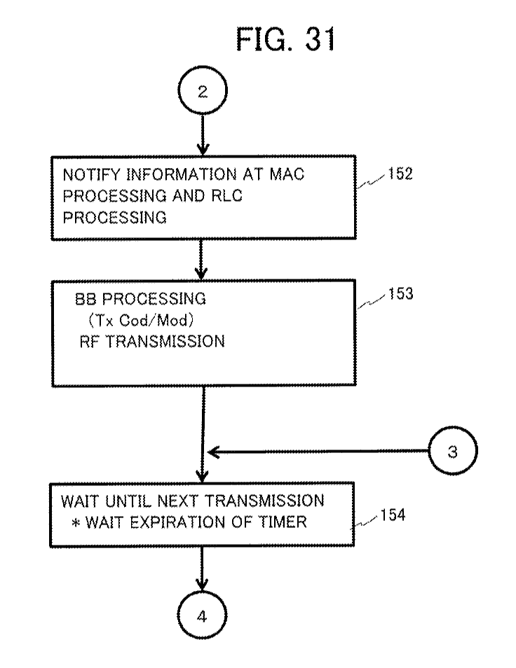

FIGS. 29, 30, and 31 are flowcharts each illustrating a process in the base station 1 after the message indicating start-up is OK is transmitted. The processes 141, 142, and 143 illustrated in FIG. 29 are the same as the processes 122, 123, and 124 illustrated in FIG. 23, and thus repeated explanations are omitted.

In 144, the CPU 37 (control unit 6A) acquires the location information of another movable object from the DB 7A, and determines whether or not there is location information of another movable object indicating that a distance from the location of the movable object 10 falls within a threshold. When the other movable object is present (Yes in 144), the process proceeds to 145. When the other movable object is not present (No in 144), the process proceeds to 146. In 145, the CPU 37 generates a message “another movable object is approaching”, and advances the process to 152.

In 146, the CPU 37 (control unit 6A) determines whether the distance between the center location of the prohibited area and the movable object 10 is smaller than the threshold of the prohibited area, and determines whether or not the movable object 10 is present in the prohibited area. When the movable object 10 is present in the prohibited area (the distance is smaller than the threshold) (Yes in 146), the process proceeds to 147. When the movable object 10 is not present in the prohibited area (No in 146), the process proceeds to 148. In 147, the CPU 37 generates a message “prohibited area” and advances the process to 152.

In 148, the CPU 37 (control unit 6A) determines whether the distance between the center location of the restricted area and the movable object 10 is smaller than a threshold of a restricted area, and determines whether the movable object 10 is present in the restricted area. When the movable object 10 is present in the restricted area (when the distance is smaller than the threshold) (Yes in 148), the process proceeds to 149. When the movable object 10 is not present in the restricted area (No in 148), the process proceeds to 150. In 149, the CPU 37 generates a message “restricted area”, and advances the process to 152.

In 150, the CPU 37 (control unit 6A) determines whether the distance between the center location of the alarm notification area and the movable object 10 is smaller than the threshold of the alarm notification area, and determines whether or not the movable object 10 is present in the alarm notification area. When the movable object 10 is present in the alarm notification area (the distance is smaller than the threshold) (Yes in 150), the process proceeds to 151. When the movable object 10 is not present in the alarm notification area (NO in 150), the process proceeds to 152. In 151, the CPU 37 generates a message “alarm notification area” and advances the process to 152.

In 152, the CPU 37 (control unit 6A) sends the message generated in the processes 145, 147, 149, and 151 to the DSP (RLC processing unit). Through the RLC process, the MAC process, and the BB process, the CPRI signal converted from the BB signal is transmitted from the REC 1A to the RE 1B. In the RE 1B, the CPRI signal converted into the original BB signal is further converted into the RF signal, radiated from the transmission antenna, and received by the UE (movable object 10).

When Method 2 and Method 3 are applied, the location information of the input apparatus 11 may be stored in the memory 38 of the base station 1, and may be transmitted to another device. The location of the input apparatus 11 may be estimated to be the location of the user of the movable object 10. This makes it possible to exercise control over an inappropriate use of the movable object 10 based on the location of the input apparatus 11.

In Method 3, the SOC chip 57 (CPU core 571, DSP core 572) of the input apparatus 11 performs the processes illustrated in FIGS. 22, 27, and 28. In the processes 102 and 121, the input apparatus 11 performs radio communication with the movable object 10, acquires the location information (GPS information 1) of the movable object 10, and acquires the location information (GPS information 2) of the input apparatus 11. The owner code is preliminarily stored in the memory 53. In 108, the input apparatus 11 receives the start-up 0K message, sends a lock releasing signal to the movable object 10, and releases the lock of the power source 41 and the propeller 42.

In the processes 128, 131, 133, and 135 illustrated in FIG. 28, a notification may be issued to the terminal 12, or an alarm may be issued from an output device (such as a speaker or a display) including the input apparatus 11. Further, control information for speed regulation or control of the movable object is sent to the movable object 10 via the input apparatus 11.

### <Operation and Effect of Second Embodiment>

The second embodiment may provide the operation and effect as described above in the first embodiment. However, the second embodiment differs from the first embodiment in that the control unit 6A which functions as the management apparatus 6 is provided in the base station 1 (the control unit is included in the base station).

Thus, the length of the transmission path for the location information of the movable object 10 is shorter than that in at least the case where the management apparatus 6 is provided separately from the base station 1. Therefore, the location information is transmitted more rapidly than in the first embodiment, and a delay in determination whether the location of the movable object is present in the area associated with the regulation and a delay in transmission of the determination result may be reduced.

In the second embodiment, the base station 1 includes a processing unit that performs a process for a first protocol among a plurality of protocols related to radio communication with the radio communication apparatus (UE). Specifically, the MAC, the RLC, the PDCP, and the like are examples of the “plurality of protocols”. The MAC is one example of the “first protocol”, and the MAC processing unit 223 is one example of the “processing unit of the first protocol”.

The MAC processing unit 223 extracts the location information of the movable object 10 from a data block based on a special value set in a head of the data block treated by the first protocol (MAC), and supplies the extracted location information to the control unit 6A. Specifically, the MAC SDU is one example of a “data block”, and the MAC PDU sub-header corresponding to the MAC SDU is one example of the “head of the data block”. Each of the MAC PDU and the MAC header may be one example of the “data block” and the “head of the data block”. The special LCID value is one example of the “special value”.

Thus, the location information is extracted from the MAC SDU, which enables the control unit 6A to acquire the location information even when the RLC and PDCP processes are not carried out. That is, the delay time may be reduced.

Further, in the configurations illustrated in FIGS. 12, 13, and 14, for example, the MAC processing unit 223 and the control unit 6A are mounted on one semiconductor chip (SOC chip). This leads to a reduction in communication delay time within the device.

Furthermore, in the second embodiment, the base station 1 receives the location information of the movable object 10 that is transmitted from the radio communication apparatus (UE) included in the input apparatus 11 that inputs information to the movable object 10. In this regard, each of the RF circuit 51 and the SOC chip 57 illustrated in FIG. 21 is one example of the “radio communication apparatus included in the input apparatus”. Thus, the location information of the movable object 10 may be transmitted to the base station 1 via the input apparatus 11. In this case, the configuration of the movable object 10 may be simplified. Further, power saving of the battery of the movable object 10 may be achieved. Furthermore, a reduction in the weight of the movable object 10 contributes to power saving.

The input apparatus 11 transmits the location information of the movable object 10 and the input apparatus 11 to the base station 1 so that the control unit 6A may acquire the location information of the input apparatus 11 as the information to be supplied to the movable object 10 that is transmitted together with the location information of the movable object 10. Thus, not only the location of the movable object 10, but also the estimated location of the user may be sent to an administrator. The configurations of the first and second embodiments may be combined as appropriate.

According to the above-described embodiments, it is possible to provide a technique capable of regulating a movement of a movable object based on the location of the movable object.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A movable object management system, comprising:
a base station configured to perform radio communication with a radio communication apparatus; and
a controller configured to determine whether a movable object is present in an area associated with a regulation on the movable object, based on location information of the movable object received from the radio communication apparatus via the base station.

2. The movable object management system according to claim 1, wherein the controller is configured to transmit, to a designated address, information to release the regulation of movement of the movable object when the movable object is not present in the area.

3. The movable object management system according to claim 1, wherein the controller is configured to transmit an alarm to a designated address when the movable object is present in the area.

4. The movable object management system according to claim 1, wherein the controller is configured to transmit movement control information for the movable object to a designated address when the movable object is present in the area.

5. The movable object management system according to claim 1, wherein the base station is configured to receive location information of the movable object transmitted from the radio communication apparatus included in the movable object.

6. The movable object management system according to claim 1, wherein the base station is configured to receive location information of the movable object transmitted from the radio communication apparatus included in an input apparatus that inputs information to the movable object.

7. The movable object management system according to claim 1, wherein the controller is configured to acquires location information of an input apparatus that inputs information to the movable object, the location information being transmitted together with location information of the movable object.

8. The movable object management system according to claim 1, wherein the controller is included in the base station.

9. The movable object management system according to claim 8, wherein the base station includes a processor configured to perform a process for a first protocol among a plurality of protocols related to radio communication with the radio communication apparatus, and
wherein the processing unit is configured to extract location information of the movable object from a data block based on a special value set in a head of the data block treated by the first protocol, and to supply the extracted location information to the controller.

10. The movable object management system according to claim 8, wherein the processor and the controller are implemented on a single semiconductor chip.

11. A base station to perform radio communication with a radio communication apparatus, the base station comprising:
a controller is configured to determine whether a movable object is present in an area associated with a regulation on the movable object, based on location information of the movable object received from the radio communication apparatus via the base station.

12. The base station according to claim 11, further comprising a processor is configured to perform a process for a first protocol among a plurality of protocols related to the radio communication with the radio communication apparatus, wherein the processor is configured to extract location information of the movable object from a data block based on a special value set in a head of the data block treated by the first protocol, and to supply the extracted location information to the controller.
